(19) United States
(12) Patent Application Publication
(10) Pub. No.: US 2016/0114732 A1
(43) Pub. Date: Apr. 28, 2016

(54) DUAL SWING CONTAINER DEVICE

(71) Applicant: TOYODA GOSEI CO., LTD., Kiyosu-shi (JP)

(72) Inventors: Shinichi SAWADA, Kiyosu-shi (JP); Kenji ASANO, Nagoya-shi (JP); Yoshinori MASATSUGU, Kiyosu-shi (JP); Kunihito KONDO, Nisshin-shi (JP)

(21) Appl. No.: 14/867,339

(22) Filed: Sep. 28, 2015

(30) Foreign Application Priority Data
Oct. 22, 2014 (JP) 2014-215321
Mar. 25, 2015 (JP) 2015-062872

(51) Int. Cl. B60R 7/00; B65D 43/26; B65D 43/22

(52) U.S. Cl. CPC B60R 7/00; B65D 43/22; B65D 43/26

(57) ABSTRACT

An opening operation assisting device of a dual swing container device according to the present invention includes: a first pressing holding section supported at one end side of a box main body so as to be able to advance toward the one end side of a cover body; a first bias member configured to bias the first pressing holding section toward the advancing direction; a second pressing holding section supported at the other end side of the box main body so as to be able to advance toward the other end side of the cover body; and a second bias member configured to bias the second pressing holding section toward the advancing direction.

### BACKGROUND

1. Technical Field

The present invention relates to a dual swing container device.

2. Related Art

Within a vehicle such as an automobile, there is often provided a dual swing container device such as a console box. As one example, a dual swing container device includes a box main body having a containing section, and a cover body that may be opened and closed from either right or left side of the containing section. The dual swing container device has shaft sections that may move forward and backward on both right and left sides of the cover body, and each of the shaft sections is engaged with an engaging hole along a circumferential edge on either right or left side of the containing section. When one of the shaft sections on the right or left side is disengaged from the engaging hole by an operating section, the cover body swings centering the other of the shaft sections that is engaged with the engaging hole on the right or left side, and opens the right or left side (see JP 2010-173440 A and JP 2000-177462 A).

In this case, after opening the cover body, the opened cover body often accidentally closes. JP 2013-220710 A discloses an arrangement for holding the cover body by a check arm at an opened position, in order to prevent such an accident. Further, JP 2789223 B1 discloses an arrangement in which a link member is provided between the cover body and the box main body, and the link member is biased by a bias member toward an opening direction of the cover body. JP 04-052946 Y discloses an arrangement in which the cover body at the opened position is supported by a rod.

However, many of the conventional dual swing container devices have a complex mechanism, including a large number of components, for holding the cover body, resulting in an increased cost.

### SUMMARY

The present invention is made in view of the above circumstances, and its object is to provide a dual swing container device with a simple configuration.

A dual swing container device according to the present invention includes:

a box main body having a containing section;

a cover body capable of opening and closing from one or the other end side of the containing section; and

an open-close mechanism configured to have the cover body open and close from the one or the other end side, wherein

the open-close mechanism includes:
a locking device configured to restrict the cover body at a closed position;
an operating section configured to unlock the restriction of the cover body at the closed position and allow the cover body to open from the one or the other end side; and
an opening operation assisting device configured to open the cover body from the one or the other end side, and hold the cover body either at a first opened position or at a second opened position, the cover body opening from the one end side at the first opened position, the cover body opening from the other end side at the second opened position, and

the opening operation assisting device includes:
a first pressing holding section supported at the one end side of the box main body so as to be able to advance toward the one end side of the cover body;
a first bias member configured to bias the first pressing holding section toward the advancing direction;
a second pressing holding section supported at the other end side of the box main body so as to be able to advance toward the other end side of the cover body; and
a second bias member configured to bias the second pressing holding section toward the advancing direction.

According to the above configuration, when one or the other side of the cover body becomes openable, the first pressing holding section and/or the second pressing holding section opens the cover body and holds the opened cover body at the first opened position or the second opened position. Thus, an operation of opening the cover body is assisted with a simple and user-friendly configuration.

Therefore, according to the present invention, it is possible to provide a dual swing container device with a simple configuration.

### BRIEF DESCRIPTION OF DRAWINGS

FIG. 1 is a perspective view of a dual swing container device according to a first embodiment;

FIG. 2 is an exploded perspective view of the dual swing container device according to the first embodiment;

FIG. 3 is a sectional view taken along I-I in FIG. 4 viewed in a direction of an arrow;

FIG. 4 is a sectional view of a cover body according to the first embodiment, in a state in which a lock of the cover body at the closed position on the right side is unlocked;

FIG. 5 is an exploded perspective view of an open-close mechanism according to the first embodiment;

FIG. 6 is a sectional view taken along F-F in FIG. 4 viewed in a direction of an arrow;

FIG. 7 is a sectional view taken along C-C in FIG. 4 viewed in a direction of an arrow;

FIG. 8 is an exploded perspective view of an opening operation assisting device according to the first embodiment;

FIG. 9 is a sectional view taken along A-A in FIG. 1 viewed in a direction of an arrow in the first embodiment, where the cover body is locked on both right and left sides at the closed position;

FIG. 10 is a sectional view taken along A-A in FIG. 1 viewed in a direction of an arrow in the first embodiment, where the lock of the cover body at the closed position on the right side is unlocked;

FIG. 11 is a sectional view taken along A-A in FIG. 1 viewed in a direction of an arrow in the first embodiment, where the cover body is at a first opened position;

FIG. 12A is an illustrative view of an accident preventing device according to the first embodiment, where the cover body is locked at the closed position;

FIG. 12B is an illustrative view of the accident preventing device according to the first embodiment, where the lock of the cover body on the right side is unlocked;

FIG. 13 is a sectional view taken along E-E in FIG. 4 viewed in a direction of an arrow;

FIG. 14 is a sectional view taken along J-J in FIG. 4 viewed in a direction of an arrow;

FIG. 15 is a perspective view of a dual swing container device according to a second embodiment;

FIG. 16 is a sectional view taken along B-B in FIG. 15 viewed in a direction of an arrow in the second embodiment, where the cover body is locked on both right and left sides at the closed position;

FIG. 17 is a sectional view taken along B-B in FIG. 15 viewed in a direction of an arrow in the second embodiment, where the lock of the cover body at the closed position on the right side is unlocked;

FIG. 18 is a sectional view taken along B-B in FIG. 15 viewed in a direction of an arrow in the second embodiment, where the cover body is at a first opened position;

FIG. 19 is a perspective view of an opening operation assisting device according to a third embodiment;

FIG. 20 is an exploded perspective view of the opening operation assisting device according to the third embodiment;

FIG. 21 is a front view of the opening operation assisting device according to the third embodiment, where a cover body is at a closed position;

FIG. 22 is a sectional view of a dual swing container device according to the third embodiment, where the cover body is at the closed position and a first opened position;

FIG. 23 is a perspective view of the opening operation assisting device according to the third embodiment, where the cover body is at the first opened position;

FIG. 24 is a perspective view of an opening operation assisting device according to a fourth embodiment;

FIG. 25 is an exploded perspective view of the opening operation assisting device according to the fourth embodiment;

FIG. 26 is a front view of the opening operation assisting device according to the fourth embodiment, where a cover body is at a closed position;

FIG. 27 is a sectional view of a dual swing container device according to the fourth embodiment, where the cover body is at the closed position and a first opened position; and

FIG. 28 is a perspective view of the opening operation assisting device according to the fourth embodiment, where the cover body is at the first opened position.

### DETAILED DESCRIPTION

### First Embodiment

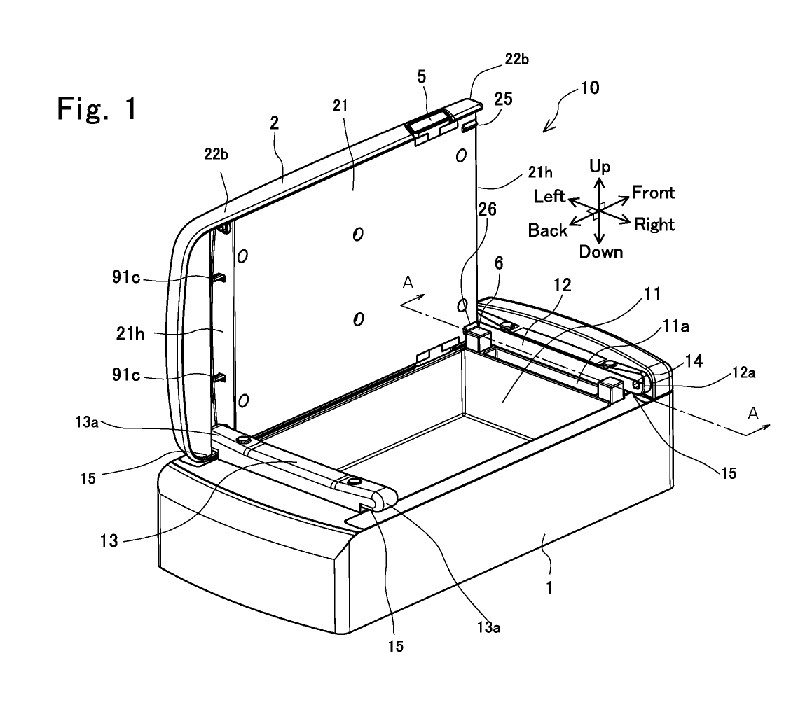

A dual swing container device according to an embodiment of the present invention will be described with reference to the drawings. In FIG. 1 and subsequent figures, the terms front, back, right, left, up, and down indicate directions as seen by a passenger seated in a driver's seat. The dual swing container device of this embodiment is attached to a center console provided in the center of an interior of a vehicle.

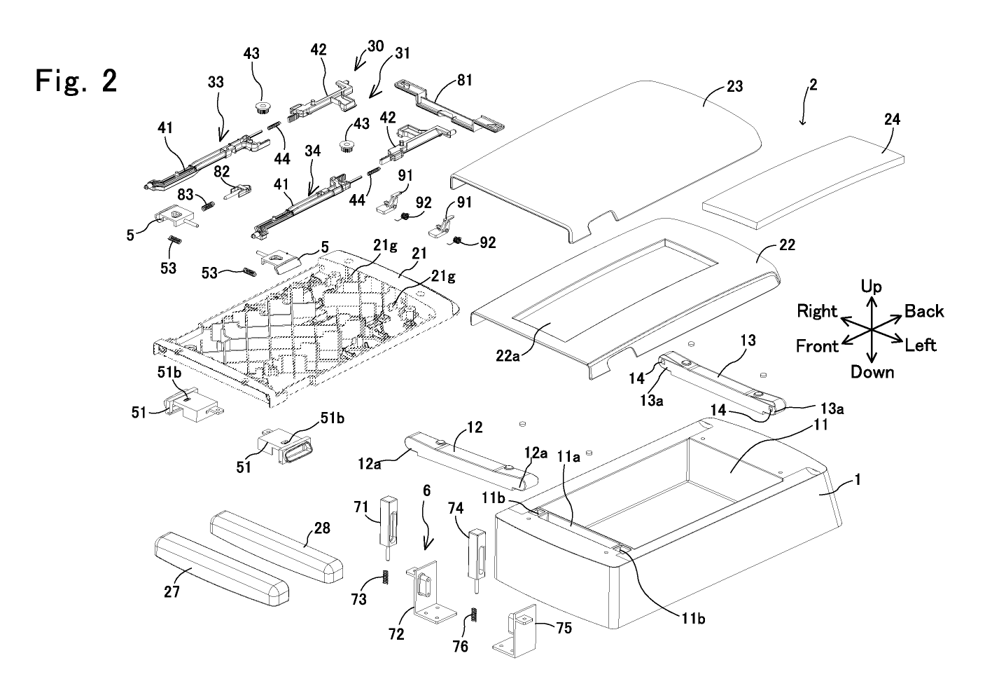

As illustrated in FIG. 1 and FIG. 2, a dual swing container device 10 in this embodiment includes a box main body 1, a cover body 2, and an open-close mechanism 30.

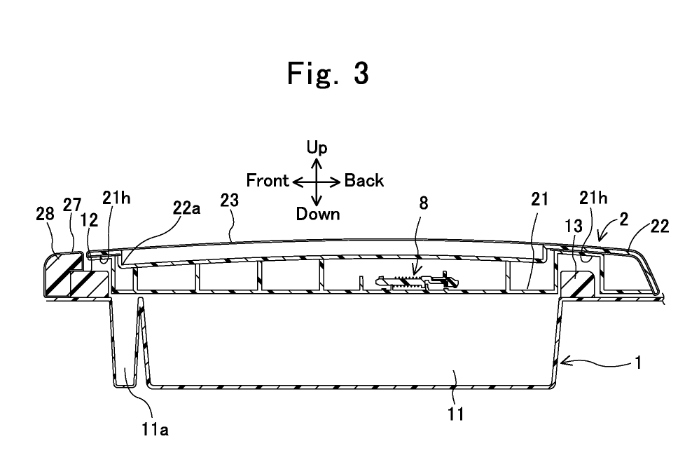

As illustrated in FIG. 3, the box main body 1 includes a recessed containing section 11, as well as a front member 12 and a rear member 13 fixed to circumferential edges on front and back sides of the containing section 11. A front section of the front member 12 is fixed to the box main body 1 in a manner fitted in a cover 28 covered with an outer surface 27. On the front side of the containing section 11, a small pocket 11a is formed.

As illustrated in FIG. 2, the front member 12 and the rear member 13 are elongated members extending right and left. The front member 12 and the rear member 13 are respectively fixed to a front circumferential edge and a rear circumferential edge of the containing section 11 of the box main body 1. Each of the front member 12 and the rear member 13 is formed with engaging holes 14 on both right and left ends that face the containing section 11. Further, the front member 12 and the rear member 13 are respectively provided with the projections 12a and 13a on both right and left ends. As illustrated in FIG. 1, the projections 12a and 13a projects outwardly in the right-left direction. A gap 15 is formed between the projections 12a and 13a and the box main body 1.

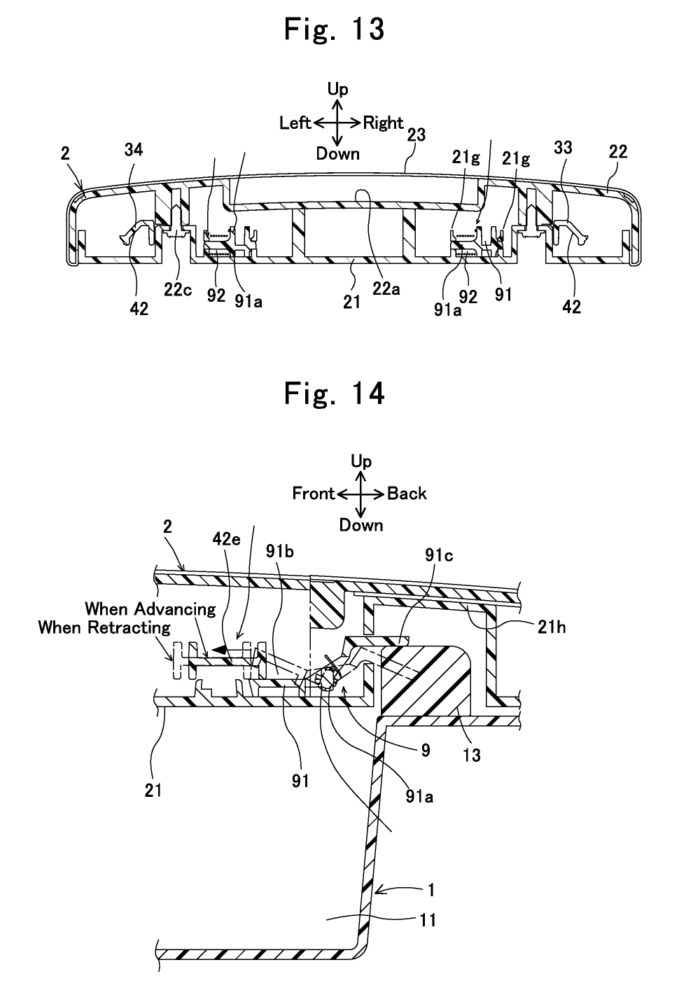

As illustrated in FIG. 2, the cover body 2 includes a lower member 21, an upper member 22, an outer surface 23, and a cushion material 24. The cushion material 24 is contained in a recessed section 22a formed on the upper member 22. The upper member 22 and the cushion material 24 are covered with the outer surface 23. The upper member 22 is fixed to the lower member 21 by a screw 22c (FIG. 13).

As illustrated in FIG. 1, on front and back sides of the lower member 21, recessed sections 21h respectively containing the front member 12 and the rear member 13 fixed to the box main body 1 are formed. Right and left sides of each of the recessed sections 21h are encircled by a side wall 22b of the upper member 22. When the cover body 2 opens, the side wall 22b comes into the gap 15 between the box main body 1 and the projection 12a of the front member 12. When the cover body 2 is completely opened, the side wall 22b is engaged with the projection 12a of the front member 12 and the projection 13a of the rear member 13, and prevents the cover body 2 from opening further. The projections 12a and 13a serve as a stopper for preventing the cover body 2 from falling over the opening side.

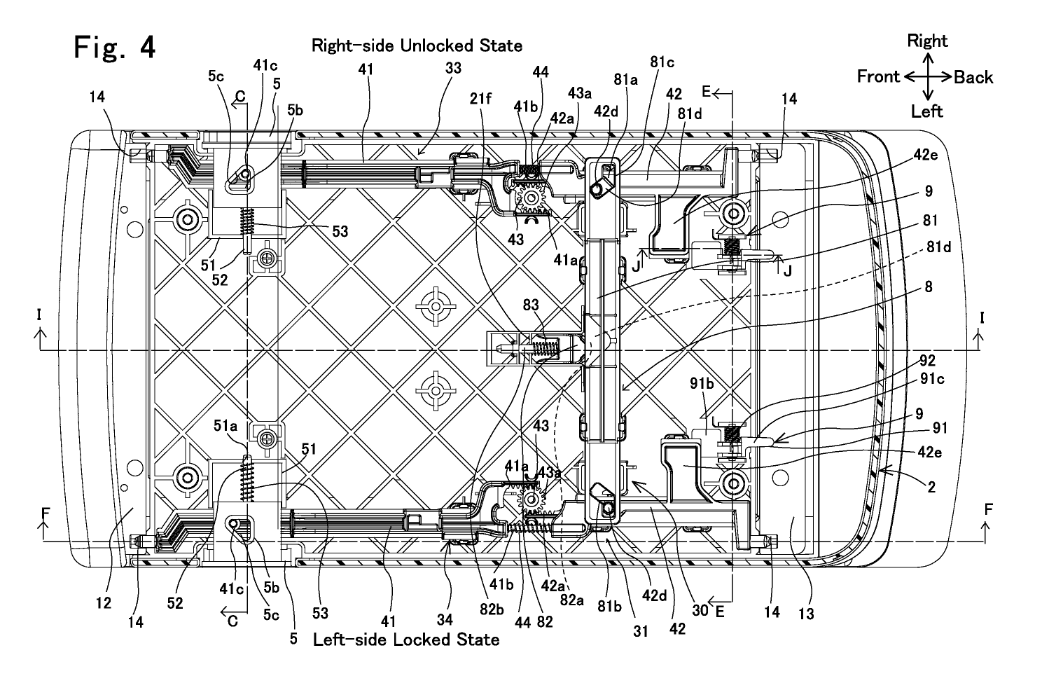

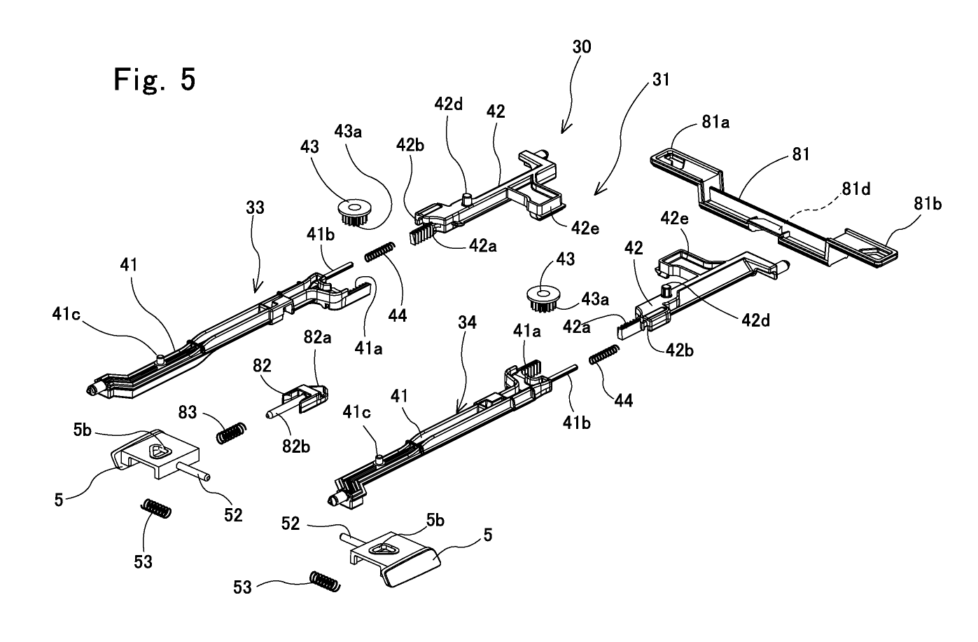

As illustrated in FIG. 2, FIG. 4, and FIG. 5, the open-close mechanism 30 includes a locking device 31, operating sections 5, and an opening operation assisting device 6.

As illustrated in FIG. 4 and FIG. 5, the locking device 31 includes a right-hand locking member 33 provided on the right side of the cover body 2, and a left-hand locking member 34 provided on the left side of the cover body 2. The right-hand locking member 33 includes a first movable member 41 disposed on the front side, a second movable member 42 disposed on the back side, and a gear member 43 disposed between the first movable member 41 and the second movable member 42. The first movable member 41 and the second movable member 42 are held by the lower member 21 of the cover body 2 movably in forward and backward directions. The gear member 43 is rotatably supported by the lower member 21 of the cover body 2. The first movable member 41 and the second movable member 42 are respectively formed with a rack gear 41a and a rack gear 42a, and the rack gears 41a and 42a are engaged with a pinion gear 43a provided on the gear member 43 at positions opposite from each other in a radial direction of the gear member 43. The first movable member 41 and the second movable member 42 advance outwardly or retract inwardly in a front-back direction in synchronization with the rotation of the gear member 43.

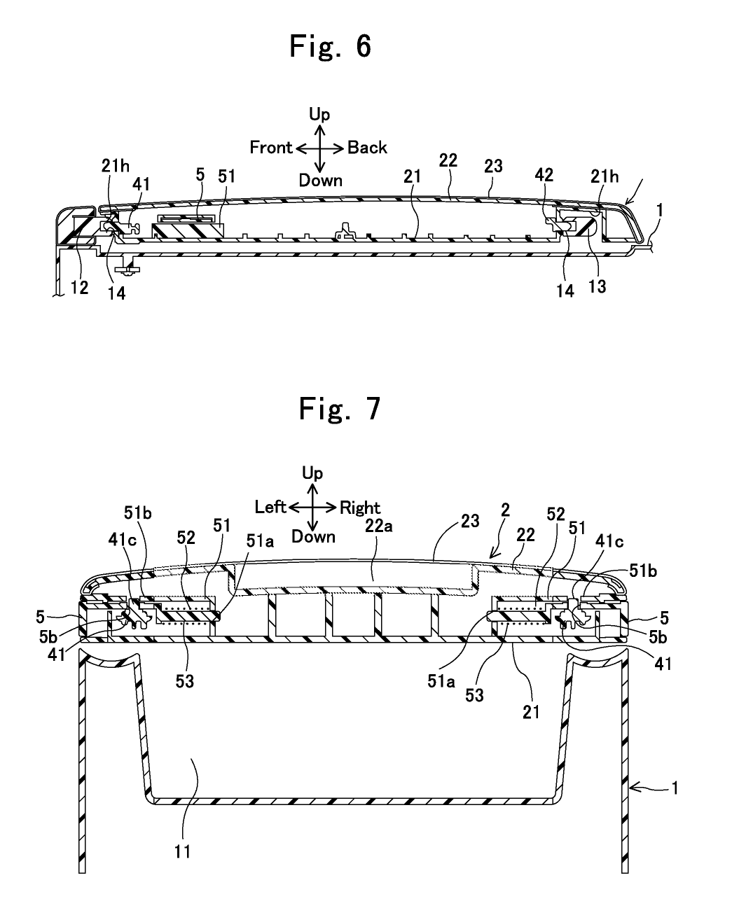

At a rear end of the first movable member 41, a pin 41b is projected. A tip end of the pin 41b is inserted into a recessed section 42b formed at a front end of the second movable member 42. The pin 41b is externally fitted with a spring 44. The spring 44 biases the first movable member 41 and the second movable member 42 outwardly in the front-back direction. As illustrated in FIG. 4 and FIG. 6, a tip end of each of the first movable member 41 and the second movable member 42 is inserted into the engaging hole 14 formed on the right side of each of the front member 12 and the rear member 13, so as to be able to move into and out of the hole. When one of the right-hand locking member 33 and the left-hand locking member 34 is disengaged from the engaging hole 14, the tip ends of the first movable member 41 and the second movable member 42 of the other of the right-hand locking member 33 and the left-hand locking member 34 constitutes a rotational axis on which the cover body 2 swings.

Similarly to the right-hand locking device 33, the left-hand locking device 34 also includes the first movable member 41, the second movable member 42, and the gear member 43. A tip end of each of the first movable member 41 and the second movable member 42 is inserted into the engaging hole 14 formed on the left side of each of the front member 12 and the rear member 13, so as to be able to move into and out of the engaging hole 14.

As illustrated in FIG. 4 and FIG. 7, the operating sections 5 are respectively provided on the right and left sides of the cover body 2. Each of the operating sections 5 on the right and left sides is contained in an operating containing section 51 fixed to the lower member 21 of the cover body 2, so as to be able to move into and out of the operating containing section 51. A leg section 52 projecting on a side surface of each of the operating sections 5 inwardly in a right-left direction is inserted, in a state externally fitted with a spring 53, into a hole 51a formed on the operating containing section 51. With this, each operating section 5 is biased by the spring 53 in a direction advancing outwardly. Further, a triangular guiding hole 5b is formed on each of the operating sections 5 on the right and left sides, and each operating containing section 51 is formed with an elongated hole 51b extending the front-back direction (FIG. 2). Each of the first movable members 41 of the right-hand locking member 33 and the left-hand locking member 34 is formed with a projecting section 41c. Each of the projecting sections 41c is inserted into the guiding hole 5b and an elongated hole 51b. When the operating section 5 is not operated, the projecting sections 41c are disposed on front end sections of the guiding hole 5b and the elongated hole 51b. When the operating section 5 is pressed, the projecting section 41c is guided along a tapered surface 5c of the guiding hole 5b, and moves outward in the right and left direction and backward of the guiding hole 5b. The first movable member 41 provided with the projecting section 41c retracts backward. Along with this, the gear member 43 is rotated and, the second movable member 42 retracts forward in synchronization with the first movable member 41. With this, the tip end of each of the first movable member 41 and the second movable member 42 is disengaged from the engaging hole 14 of the box main body 1 to open the cover body 2.

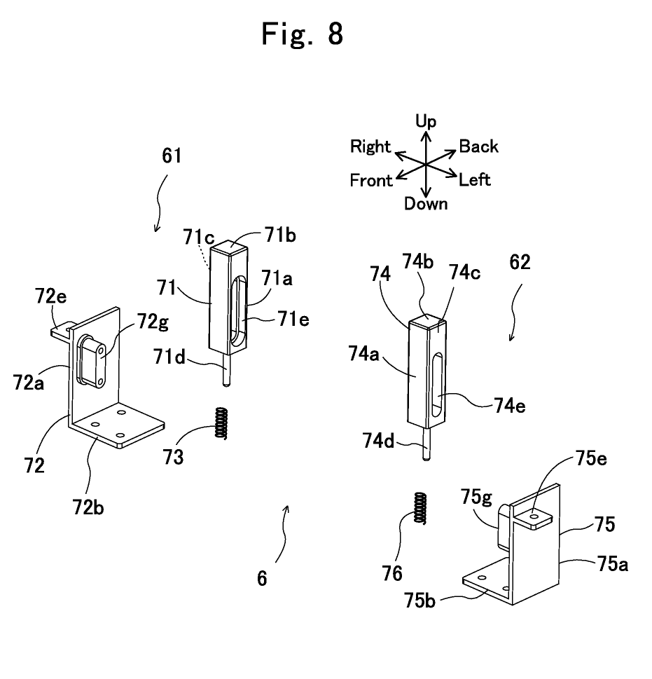

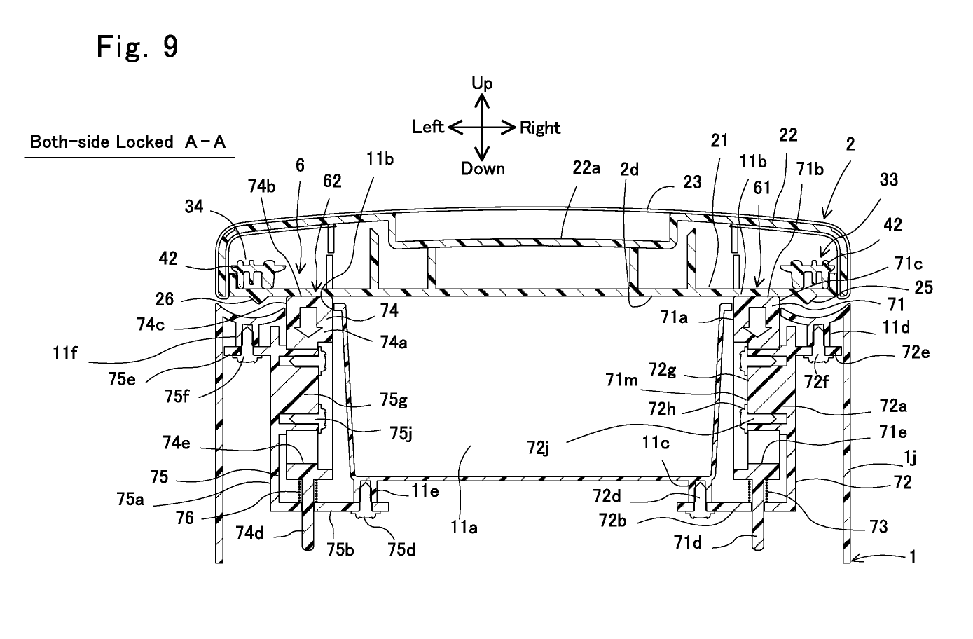

As illustrated in FIG. 8 and FIG. 9, the opening operation assisting device 6 is provided within an inner space between the pocket 11a on the front side of the box main body 1 and an outer wall 1j. The opening operation assisting device 6 includes a right-hand device 61 for opening the right side of the cover body 2 and holding the right side of the cover body 2 at an opened position, and a left-hand device 62 for opening the left side of the cover body 2 and holding the left side of the cover body 2 at an opened position. A position at which the right side of the cover body 2 is fully opened is referred to a first opened position, and a position at which the left side of the cover body 2 is fully opened is referred to a second opened position.

The right-hand device 61 includes a first pressing holding section 71, a first guiding member 72, and a first bias member 73. The first pressing holding section 71 is supported on the right side of the box main body 1 so as to be able to advance in an opening direction of the right side of the cover body 2. The first pressing holding section 71 includes an elongated section 71a extending in an up and down direction, a contact surface 71b formed at a top end of the elongated section 71a, a holding surface 71c provided on a right side of the elongated section 71a, a leg section 71d projected from a bottom end of the elongated section 71a, and an elongated hole 71e formed in the center of the elongated section 71a. The elongated section 71a is inserted into a through hole 11b formed along a right circumferential edge of the containing section 11 of the box main body 1, so as to be able to move into and out of the through hole 11b. When the right side of the cover body 2 opens and is substantially upright, the holding surface 71c of the elongated section 71a is positioned near a rear surface 2d of the cover body 2, and extends in a direction along the rear surface 2d of the cover body 2.

The first guiding member 72 is an L-shaped thin leaf, and includes a guiding section 72a extending along the up and down direction and a fixation section 72b flexing leftward from the bottom of the guiding section 72a. A tip end of the fixation section 72b is fixed, using a screw 72d, to an attaching section 11c projecting downwardly at the bottom right of the pocket 11a of the box main body 1. A projecting piece 72e projecting from the top of the guiding section 72a is fixed, using a screw 72f, to an attaching section 11d projecting downwardly from the right circumferential edge of the containing section 11 of the box main body 1. The guiding section 72a is provided with a protrusion 72g extending in the up and down direction. The protrusion 72g is inserted into the elongated hole 71e formed on the first pressing holding section 71 movably in the up and down direction. The protrusion 72g is screwed by a screw 72j. By having a head 72h of the screw 72j be slidably engaged with a stepped section 71m formed within the elongated hole 71e, the protrusion 72g is slidably inserted into the elongated hole 71e while preventing the protrusion 72g from falling out of the elongated hole 71e. When the protrusion 72g is positioned at an upper end of the elongated hole 71e, the first pressing holding section 71 is positioned at a lowermost position. A lower end of the elongated hole 71e defines an uppermost position of the first pressing holding section 71.

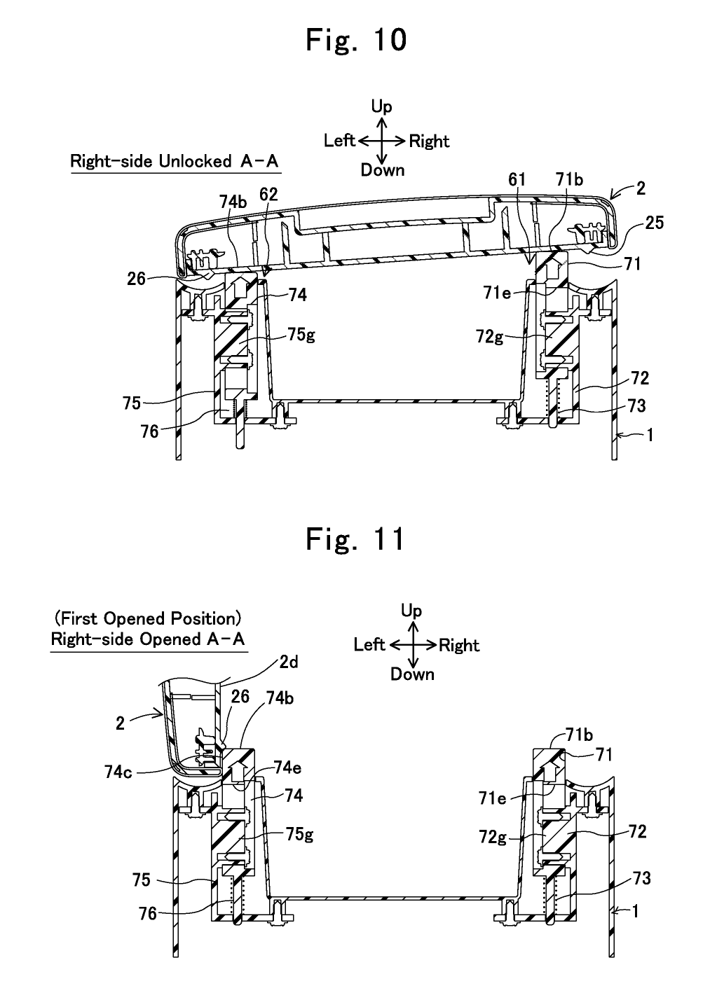

The first bias member 73 is a coil spring. The first bias member 73 is externally fitted around the leg section 71d of the first pressing holding section 71. An upper end of the first bias member 73 is engaged with a lower surface of the elongated section 71a of the first pressing holding section 71, and a lower end of the first bias member 73 is engaged with the fixation section 72b of the first guiding member 72. The first bias member 73 biases the first pressing holding section 71 to the advancing direction. With this, as illustrated in FIG. 10, when a lock of the cover body 2 on the right side at the closed position is unlocked by the operating section 5 and the cover body 2 may be opened from the right side, the first pressing holding section 71 pushes the right side of the cover body 2 up with the contact surface 71b and pushes the right side of the cover body 2 to a temporary opened position.

Further, when the left side of the cover body 2 opens, the first pressing holding section 71 engages with the right side of the cover body 2 and holds the cover body 2 at the second opened position. As illustrated in FIG. 1 and FIG. 9, a first engaging section 25 having a triangular section is projecting from a right circumferential edge on the front side of the lower member 21 of the cover body 2. When the left side of the cover body 2 opens to the second opened position, the first pressing holding section 71 moves upward and engages with a tapered surface of the first engaging section 25. With this, the cover body 2 is held at the second opened position. Even if an external force is applied to the cover body 2 to cause the cover body 2 to return to the closed position, the cover body 2 is locked by the first pressing holding section 71 and may not fall.

The left-hand device 62 includes a second pressing holding section 74, a second guiding member 75, and a second bias member 76. The second pressing holding section 74 is supported on the left side of the box main body 1 so as to be able to advance in an opening direction of the left side of the cover body 2. Similarly to the first pressing holding section 71, the second pressing holding section 74 includes an elongated section 74a, a contact surface 74b formed at a top end of the elongated section 74a, a holding surface 74c formed on a left side of the elongated section 74a, a leg section 74d projected from a bottom end of the elongated section 74a, and an elongated hole 74e formed in the center of the elongated section 74a. The elongated section 74a is inserted into a through hole 11b formed along a left circumferential edge of the containing section 11 of the box main body 1, so as to be able to move into and out of the hole.

Similarly to the first guiding member 72, the second guiding member 75 includes a guiding section 75a having a protrusion 75g extending along the up and down direction, and a fixation section 75b. A tip end of the fixation section 75b is fixed, using a screw 75d, to an attaching section 11e projecting downwardly at the bottom left of the pocket 11a of the box main body 1. A projecting piece 75e projecting leftwardly from the top of the guiding section 75a is fixed, using a screw 75f, to an attaching section 11f projecting downwardly from the left circumferential edge of the containing section 11 of the box main body 1. The protrusion 75g of the guiding section 75a is inserted in the elongated hole 74e formed in the second pressing holding section 74 movably in the up and down direction. The protrusion 75g is prevented, by a screw 75j, from moving out from the elongated hole 74e.

The second bias member 76 is a coil spring. The second bias member 76 is externally fitted around the leg section 74d of the second pressing holding section 74. An upper end of the second bias member 76 is engaged with a lower surface of the elongated section 74a of the second pressing holding section 74, and a lower end of the second bias member 76 is engaged with the fixation section 75b of the second guiding member 75. The second bias member 76 biases the second pressing holding section 74 to the advancing direction. When a lock of the cover body 2 on the left side at the closed position is unlocked by the operating section 5 and the cover body 2 may be opened from the left side, the second pressing holding section 74 pushes the left side of the cover body 2 up an opens the left side of the cover body 2 to a temporary opened position. When the lock of the cover body 2 on the right side at the closed position is unlocked by the operating section 5 and the right side of the cover body 2 is opened, the second pressing holding section 74 engages with a tapered surface of a second engaging section 26 of the left side of the cover body 2 and holds the cover body 2 at the first opened position.

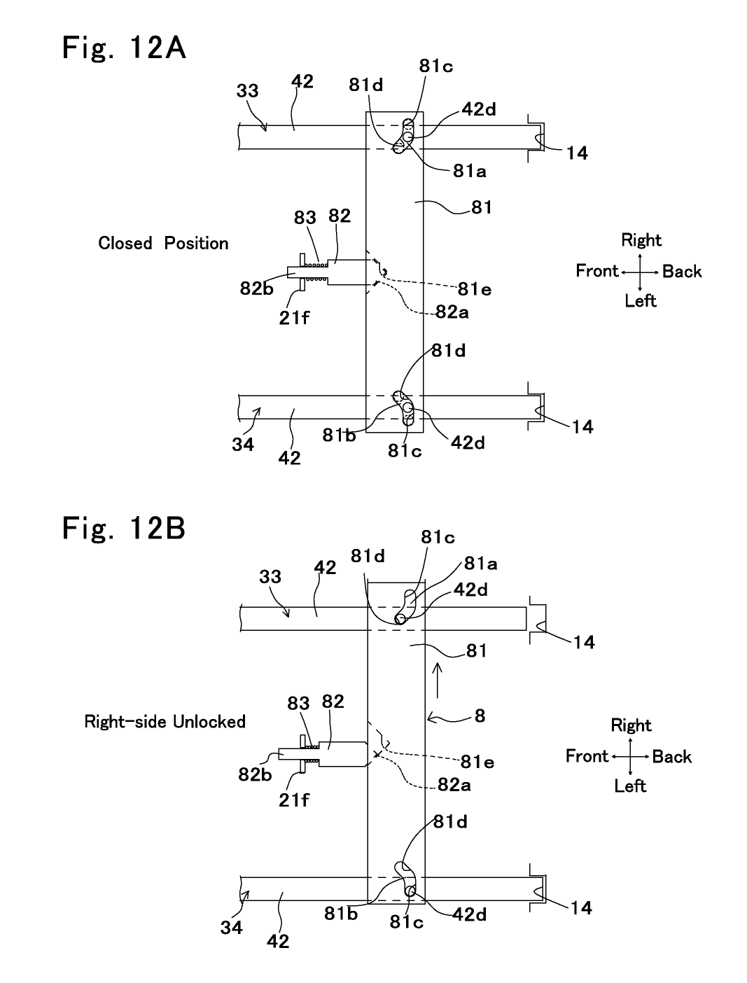

Further, as illustrated in FIG. 2, FIG. 3, and FIG. 4, the open-close mechanism 30 includes an accident preventing device 8 for preventing the right-hand locking member 33 and the left-hand locking member 34 from operating at the same time. The accident preventing device 8 includes an intervening member 81 and a position adjusting member 82. As illustrated in FIG. 12, the intervening member 81 is an elongated plate-like body extending along the right-left direction, and formed with guiding holes 81a and 81b on both right and left sides. Each of the guiding holes 81a and 81b includes a rear section 81c formed outward in the right-left direction, and a tapered section 81d extending from the rear section 81c inwardly in the right-left direction in a tapered manner. Into the guiding holes 81a and 81b on both right and left sides, protruding sections 42d provided on the second movable members 42 of the right-hand locking member 33 and the left-hand locking member 34 are inserted. In a central section of the intervening member 81, a guiding surface 81e is formed. The guiding surface 81e is tapered backward toward the center in the right-left direction.

The position adjusting member 82 is provided in the center of the cover body 2 in the right-left direction. The position adjusting member 82 includes a pressing surface 82a formed at the back side and a leg section 82b projecting at the front side. The pressing surface 82a is in contact with the guiding surface 81e of the intervening member 81. The leg section 82b is, in a state externally fitted with a spring 83, inserted into a hole in a holding wall 21f formed on the lower member 21 of the cover body 2. The spring 83 biases the position adjusting member 82 backward so that the holding wall 21f and the position adjusting member 82 are spaced apart from each other. Therefore, the position adjusting member 82 presses the intervening member 81 backward with the pressing surface 82a.

As illustrated in FIG. 12A, when both of the right-hand locking member 33 and the left-hand locking member 34 are engaged with the engaging holes 14 and in the locked state, the protruding sections 42d inserted into the guiding holes 81a and 81b on the right and left sides of the intervening member 81 are positioned in the middle of the rear section 81c and the tapered section 81d.

As illustrated in FIG. 12B, when the right-hand locking member 33 is disengaged from the engaging hole 14 and the locked state on the right side is unlocked, the protruding section 42d of the second movable member 42 of the right-hand locking member 33 moves forward along the tapered section 81d of the guiding hole 81a against the pressing force of the position adjusting member 82, and moves the intervening member 81 rightward. The protruding section 42d of the second movable member 42 of the left-hand locking member 34 moves outwardly in the right-left direction along the rear section 81c of the guiding hole 81b. The movement of the protruding section 42d of the left-hand locking member 34 in the front-back direction is prevented at the rear section 81c. With this, the movement of the left-hand locking member 34 is locked to prevent accidental unlocking of the locked state.

On the other hand, when the left-hand locking member 34 is disengaged from the engaging hole 14 and the locked state on the left side is unlocked, the intervening member 81 is moved in an opposite direction from the case when the locked state on the right side is unlocked, and the movement of the protruding section 42d of the right-hand locking member 33 in the front-back direction is prevented at the rear section 81c. With this, the movement of the right-hand locking member 33 is locked to prevent accidental unlocking of the locked state.

Here, when the pressing force of the operating section 5 is unlocked while the cover body 2 is open, the right-hand locking member 33 or the left-hand locking member 34 that is open advances outward in the front-back direction of the cover body 2. If the cover body 2 is closed in this state, it is not possible to insert the right-hand locking member 33 or the left-hand locking member 34 into the engaging hole 14.

Therefore, as illustrated in FIG. 13 and FIG. 14, in this embodiment, the open-close mechanism 30 is provided with control devices 9 for respectively restricting advancement of the right-hand locking member 33 and the left-hand locking member 34 when open in the front-back direction of the cover body 2. The control device 9 for restricting advancement of the right-hand locking member 33 is the same as the control device 9 for restricting advancement of the left-hand locking member 34. Therefore, the control device 9 for restricting advancement of the right-hand locking member 33 will be described.

The control device 9 for restricting advancement of the right-hand locking member 33 includes a restricting member 91 that is swingably supported by the lower member 21 of the cover body 2, and a spring 92. The restricting member 91 includes a rotary shaft 91a, a springboard section 91b extending to the one end side of the rotary shaft 91a in the radial direction, and a projecting section 91c extending to the other end side of the rotary shaft 91a in the radial direction. The rotary shaft 91a is externally fitted with the spring 92. Both ends of the rotary shaft 91a in the shaft direction are supported, in a freely rotatable manner, by a bearing section 21g projecting from the lower member 21 of the cover body 2. As illustrated in FIG. 14, the springboard section 91b is disposed along a moving path of an arm section 42e that projects to the second movable member 42 of the right-hand locking member 33. The projecting section 91c projects to the recessed section 21h on the back side of the cover body 2, and is disposed so as to be able to be brought into contact with the rear member 13 of the box main body 1.

One end side of the spring 92 is engaged with the lower member 21 of the cover body 2, and the other end side of the spring 92 is engaged with the projecting section 91c. The spring 92 biases the restricting member 91 so that the projecting section 91c swings downward. When the cover body 2 is at the closed position, the projecting section 91c is brought into contact with the rear member 13 and swings upward. Then, the springboard section 91b swings downward to allow advancement of the second movable member 42 of the right-hand locking member 33, and the second movable member 42 is engaged with the engaging hole 14. With this, the cover body 2 is restricted at the closed position.

As illustrated in FIG. 14 and FIG. 4, when the second movable member 42 of the right-hand locking member 33 is disengaged from the engaging hole 14 by the operating section 5 and the second movable member 42 is retracted, the arm section 42e of the second movable member 42 is moved on the front side from the springboard section 91b. When the right side of the cover body 2 opens, the projecting section 91c moves away from the rear member 13 fixed to the box main body 1. As indicated by an alternate long and short dash line in FIG. 14, by the spring 92, the projecting section 91c is flipped down and the springboard section 91b is flipped up. When the pressing force of the operating section 5 is unlocked, the second movable member 42 attempts to advance backward, but advancement of the arm section 42e of the second movable member 42 is prevented as the springboard section 91b is flipped up by the spring 92. When advancement of the second movable member 42 is restricted, advancement of the first movable member 41 is also restricted.

Next, when the right side of the cover body 2 is closed, the projecting section 91c is pushed upward by the rear member 13 of the box main body 1, and the springboard section 91b moves downward. With this, the springboard section 91b retracts from the moving path of the second movable member 42, and advancement of the second movable member 42 becomes possible. The second movable member 42 is engaged with the engaging hole 14, and locked at the closed position.

In this embodiment, when the operating section 5 of the cover body 2 on the right side is pressed, the right-hand locking member 33 is disengaged from the engaging hole 14, and the locked state at the closed position is unlocked. When the locked state at the closed position of the cover body 2 on the right side is unlocked, as illustrated in FIG. 8, the first pressing holding section 71 on the right side moves upward by the biasing force of the first bias member 73 to pushes the right side of the cover body 2 up to a temporary opened position. Although there is a case in which the cover body 2 is not fully opened at the first opened position due to mass moment, the biasing force of the first bias member 73 remains. The remaining biasing force of the first bias member 73 alleviates a load required for the opening operation by an operator. Thus, it is possible to alleviate an operation of opening from the temporary opened position to the first opened position.

As illustrated in FIG. 11, when the cover body 2 opens to the first opened position, the second pressing holding section 74 on the left side moves upward and the contact surface 74b of the second pressing holding section 74 is engaged with the second engaging section 26 on the left side projecting toward the rear surface 2d of the cover body 2. With this, the cover body 2 is held at the first opened position.

The tip end of each of the first movable member 41 and the second movable member 42 of the left-hand locking member 34 fitted in the engaging hole 14 forms a rotational axis when the cover body 2 swings. The cover body 2 is positioned at the first opened position after being opened substantially vertically. When the cover body 2 is positioned at the first opened position, a gravity center of the mass of the cover body 2 is positioned substantially above the rotational axis, and therefore the rotational moment of the cover body 2 decreases. An inner side to which the rear surface 2d of the cover body 2 faces in a state in which the cover body 2 is upright substantially vertically at the first opened position is held by the second pressing holding section 74.

Further, as illustrated in FIG. 1, when the cover body 2 is positioned at the first opened position, the side wall 22b of the upper member 22 of the cover body 2 comes into the gaps 15 formed between the box main body 1 and the projection 12a of the front member 12 and the projection 13a of the rear member 13 on the left side and engaged with lower surfaces of the projections 12a and 13a. Therefore, it is possible to prevent the cover body 2 from falling over outwardly. In this manner, when the cover body 2 is positioned at the first opened position, by the upward force of the second pressing holding section 74 and the engagement of the left side of the side wall 22b with the projections 12a and 13a, it is possible to prevent the cover body 2 from falling over inwardly and outwardly.

When the cover body 2 is closed, the cover body 2 is pushed down. The second pressing holding section 74 on the left side is pushed down by the cover body 2. Next, the cover body 2 pushes the first pressing holding section 71 on the right side down. The right-hand locking member 33 is engaged with the engaging hole 14 of the right side of the box main body 1, and the right side of the cover body 2 is restricted at the closed position.

When the left side of the cover body 2 is opened, the operating section 5 on the left side is pressed in, and the left-hand locking member 34 is disengaged from the engaging hole 14 of the box main body 1 on the left side, and the locked state at the closed position is unlocked. Then, the second pressing holding section 74 on the left side moves upward to push the left side of the cover body 2 upward. When the left side of the cover body 2 is opened to the second opened position, the first pressing holding section 71 on the right side moves upward, and the contact surface 71b of the first pressing holding section 71 is engaged with the first engaging section 25 on the right side projecting toward the rear surface 2d of the cover body 2. Further, the side wall 22b of the cover body 2 is engaged with the projections 12a and 13a of the front member 12 and the rear member 13 on the right side. In this manner, by the upward force of the first pressing holding section 71 and the engagement of the right side of the side wall 22b with the projections 12a and 13a, it is possible to hold the cover body 2 at the second opened position.

### Second Embodiment

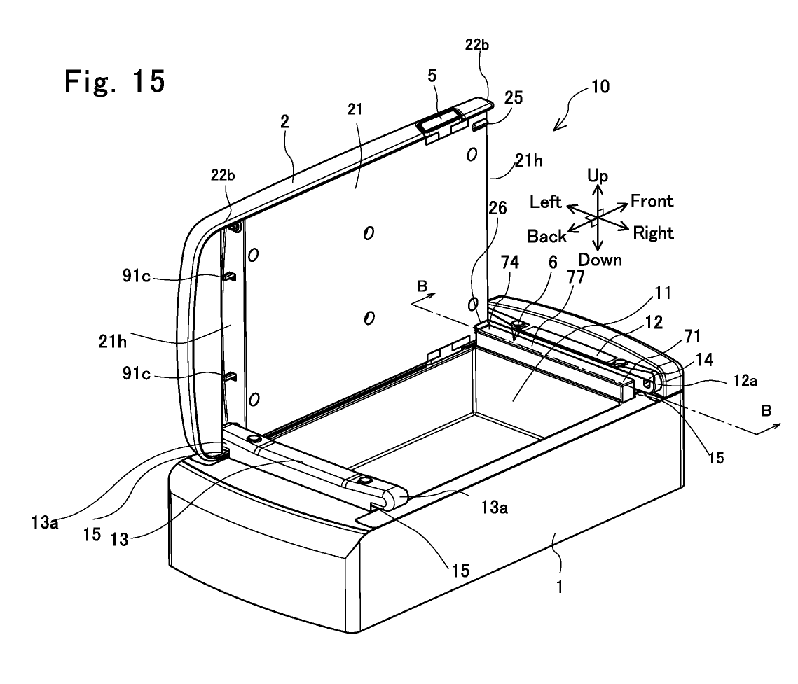

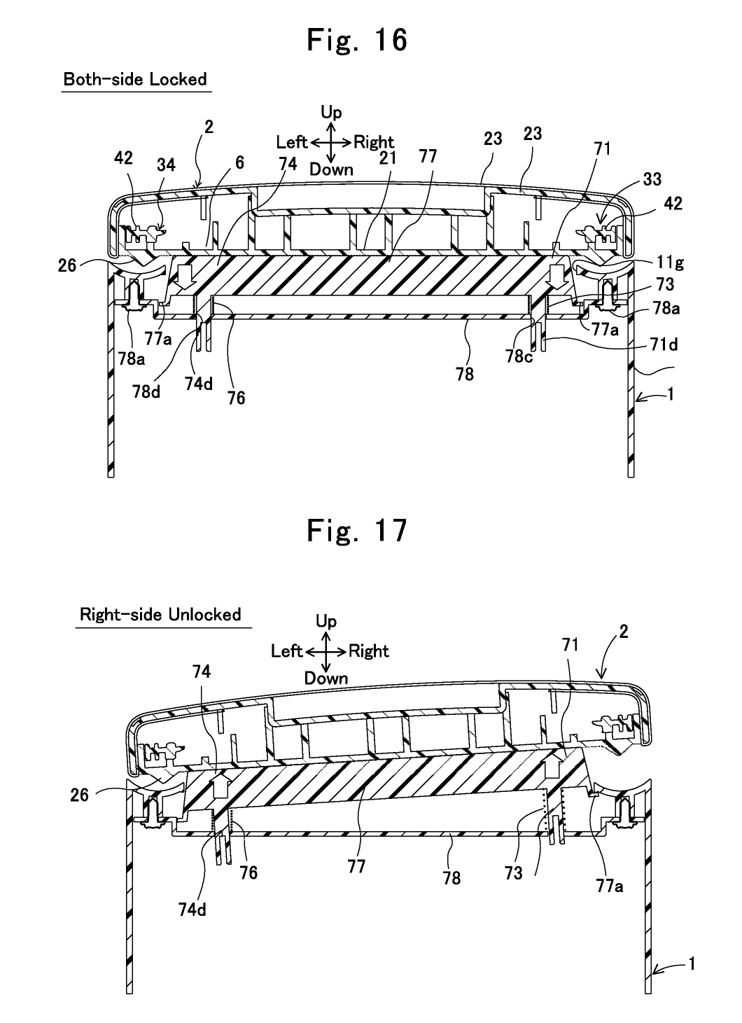

According to the dual swing container device 10 of a second embodiment, as illustrated in FIG. 15, the opening operation assisting device 6 includes a swinging body 77. The swinging body 77 extends from right to left along the opening circumferential edge of the containing section 11 of the box main body 1. As illustrated in FIG. 16, the swinging body 77 is able to swing so as to press the right or the left side of the cover body 2 toward the opened position. For the end of the swinging body 77 on the right side, the first pressing holding section 71 is provided. For the end of the swinging body 77 on the left side, the second pressing holding section 74 is provided. Under the first pressing holding section 71 and the second pressing holding section 74, the leg sections 71d and 74d are projected. Between a front wall of the containing section 11 of the box main body 1 and the outer wall 1j of the box main body 1, a guiding member 78 is provided. Both right and left sides of the guiding member 78 are fixed by screws 78a respectively to the right and left sections of the opening circumferential edge of the containing section 11 of the box main body 1.

The leg sections 71d and 74d are respectively inserted in through holes 78c and 78d formed on the guiding member 78. A slight gap is included in each of the through holes 78c and 78d with the corresponding inserted leg section 71d or 74d, and the leg sections 71d and 74d are freely swingable within the through holes 78c and 78d. With this, the swinging body 77 is able to swing with respect to the box main body 1.

Between the circumferential edge of the through hole 78c on the right side and a base end circumferential edge of the leg section 71d of the first pressing holding section 71, the first bias member 73 is provided. The first pressing holding section 71 is biased toward the advancing direction (upward direction) by the first bias member 73. Further, between the circumferential edge of the through hole 78d on the left side and a base end circumferential edge of the leg section 74d of the second pressing holding section 74, the second bias member 76 is provided. The second pressing holding section 74 is biased toward the advancing direction by the second bias member 76. Projecting pieces 77a are provided at lower sections of the swinging body 77 on both right and left. When the swinging body 77 advances, the projecting piece 77a is engaged with a circumferential edge of a through hole 11g of the box main body 1 on the front side, and defines an uppermost position of the swinging body 77.

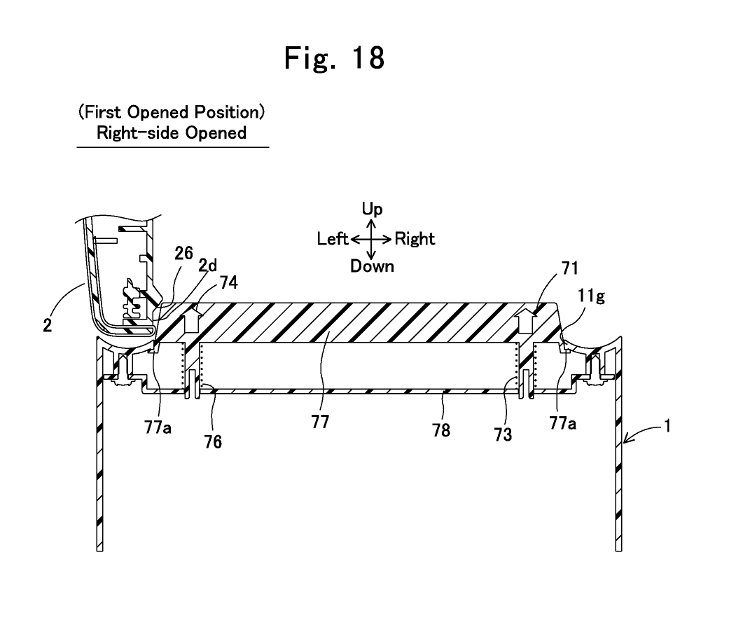

As illustrated in FIG. 17, when the right side of the cover body 2 opens, the first pressing holding section 71 first advances to push the right side of the cover body 2 up. As illustrated in FIG. 18, when a degree of opening of the right side of the cover body 2 increases and the right side of the cover body 2 opens to the first opened position, the second pressing holding section 74 advances to be engaged with the left side of the cover body 2. In this case, the first pressing holding section 71 first advances, then the second pressing holding section 74 advances, and the second pressing holding section 74 is engaged with the second engaging section 26 of the cover body 2 on the left side. Timings of advancement of the first pressing holding section 71 and the second pressing holding section 74 are different. Further, amounts of advancement of the first pressing holding section 71 and the second pressing holding section 74 are sometimes different.

In this embodiment, by causing the swinging body 77 to swing, the timings and the amounts of advancement of the first pressing holding section 71 and the second pressing holding section 74 may be made different. By allowing delay in the timings of advancement, and changing the amounts of advancement if necessary, of the first pressing holding section 71 and the second pressing holding section 74, and making the amounts of advancement to be different as needed, it is possible to open the cover body 2 smoothly, and to hold the opened cover body 2 stably at the first opened position or the second opened position.

### Third Embodiment

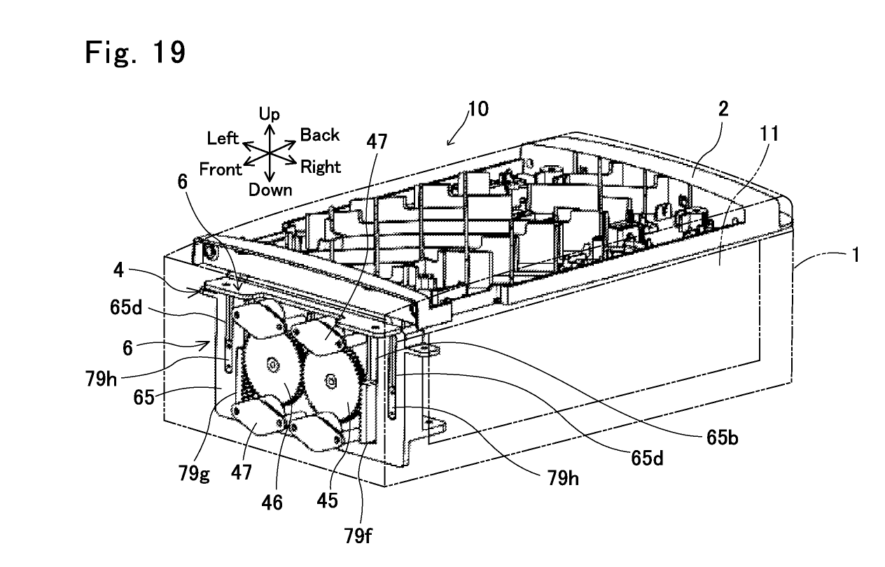

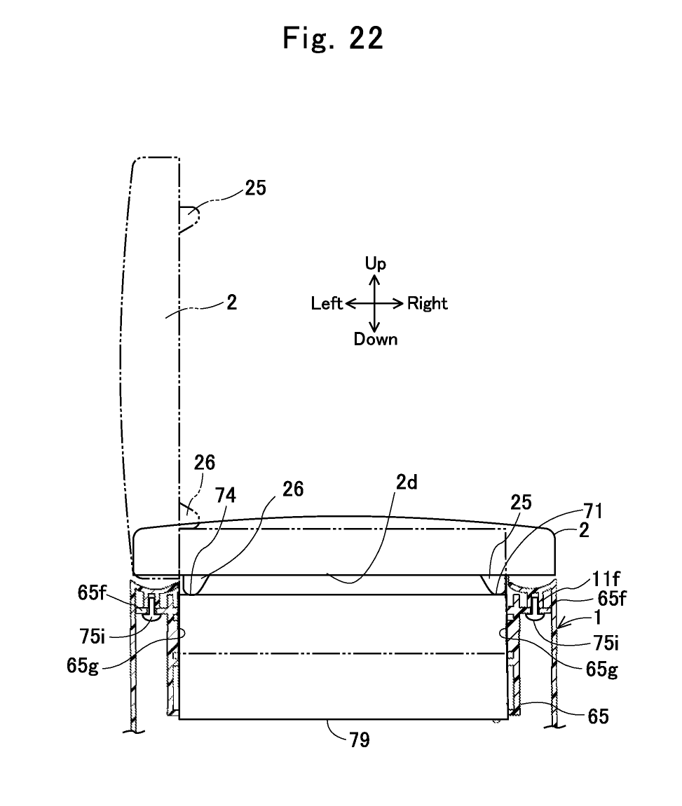

According to the dual swing container device 10 of a third embodiment, as illustrated in FIG. 19 to FIG. 21, the opening operation assisting device 6 includes a base member 65, a pressing body 79, and an advancement retraction interlocking mechanism 4. The base member 65 is fixed to an opening circumferential edge on the front side of the containing section 11 of the box main body 1. The base member 65 extends from a right end to a left end along the opening circumferential edge of the containing section 11 of the box main body 1. As illustrated in FIG. 22, on each of both right and left ends of the base member 65, a flange section 65f is provided. The flange sections 65f is fixed, by a screw 75i, to the attaching section 11f projecting toward the rear surface of the opening circumferential edge of the containing section 11 of the box main body 1.

The pressing body 79 extends from the right end to the left end along the opening circumferential edge of the containing section 11 of the box main body 1. The pressing body 79 is held movably up and down by a holding wall 65g provided on the base member 65. The pressing body 79 is able to advance so as to press the ends of the cover body 2 on the right and left sides toward the opened position.

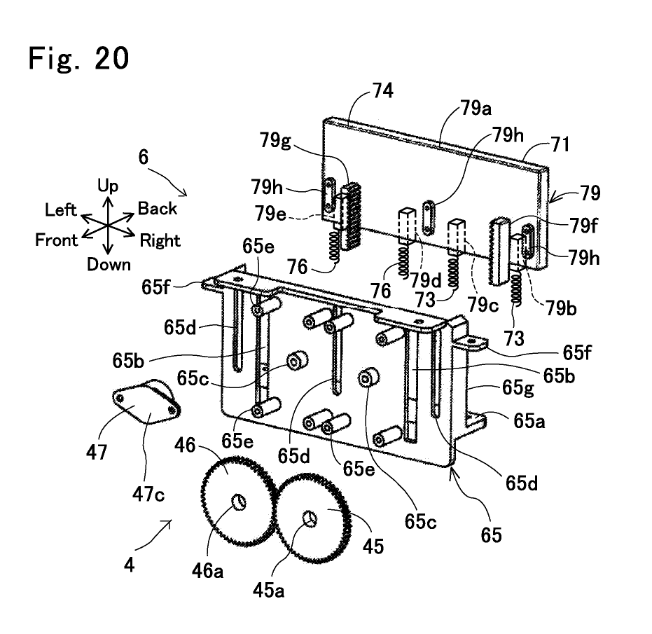

As illustrated in FIG. 20 to FIG. 22, the first pressing holding section 71 is provided on the right side of an upper surface 79a of the pressing body 79, and the second pressing holding section 74 is provided on the left side of the upper surface 79a of the pressing body 79. When the cover body 2 is closed, the first pressing holding section 71 and the second pressing holding section 74 are respectively brought into contact with the first engaging section 25 and the second engaging section 26 projecting from the rear surface 2d of the cover body 2. Further, when the cover body 2 starts to open from the closed state, the first pressing holding section 71 and the second pressing holding section 74 are respectively brought into contact with the first engaging section 25 and the second engaging section 26 projecting inside the cover body 2, and move the first engaging section 25 and the second engaging section 26 upward to assist the opening operation of the cover body 2. While the right side of the cover body 2 rotates after starting to open to the fully opened first opened position, the second pressing holding section 74 on the left side remains in contact with the second engaging section 26 of the cover body 2 and holds the cover body 2 at the first opened position. While the left side of the cover body 2 rotates after starting to open to the fully opened second opened position, the first pressing holding section 71 on the right side remains in contact with the first engaging section 25 of the cover body 2 and holds the cover body 2 at the second opened position.

Inside the pressing body 79, spring chambers 79b, 79c, 79d, and 79e are provided respectively on a right end side, a right middle side, a left middle side, and a left end side. In the spring chambers 79b and 79c provided on the right end side and the right middle side, first bias members 73 is contained. In the spring chambers 79d and 79e provided on the left middle side and the left end side, second bias members 76 is contained. The first bias members 73 and the second bias members 76 are helical compression springs. Upper ends of the first bias members 73 and the second bias members 76 are respectively engaged with ceiling surfaces of the spring chambers 79b to 79e, and lower ends thereof are engaged with a seating section 65a provided projectingly on the base member 65, so as to bias the pressing body 79 upward, i.e, in the advancing direction.

The advancement retraction interlocking mechanism 4 includes a first rack section 79f, a second rack section 79g, a first pinion 45, a second pinion 46, and a damper device 47. The first rack section 79f is provided projectingly on a front side of the pressing body 79 on the right side. The second rack section 79g is provided projectingly on a front side of the pressing body 79 on the left side. The first rack section 79f and the second rack section 79g have rack gears at positions facing each other. The first pinion 45 and the second pinion 46 respectively have supporting holes 45a and 46a at their centers of rotation. The first pinion 45 and the second pinion 46 are rotatably supported with respect to the base member 65 by inserting rotary shafts 65c provided on the base member 65 on the right and left sides into the supporting holes 45a and 46a. The first pinion 45 and the second pinion 46 are spur gears of the same size with the same number of teeth, and are in external contact with each other.

On the right and left sides, the base member 65 is provided with slits 65b movable up and down respectively along the first rack section 79f and the second rack section 79g. The first rack section 79f and the second rack section 79g are fitted into the slits 65b by insertion in a manner movable up and down, and tip ends of the first rack section 79f and the second rack section 79g project forward from the slits 65b. The first rack section 79f and the second rack section 79g are respectively engaged with the first pinion 45 and the second pinion 46 at sections projecting from the slits 65b.

The base member 65 is formed with guiding holes 65d on a right-side section, a middle section, and a left-side section. The guiding holes 65d extend by the same length in the up and down direction of the base member 65. With the guiding holes 65d, engagement protrusions 79h provided on the pressing body 79 on a right-side section, a middle section, and a left-side section are respectively engaged so as to be guided in the up and down direction. Upper ends of the guiding holes 65d define a maximum advancing position of the pressing body 79, and lower ends of the guiding holes 65d define a maximum retracting position of the pressing body 79.

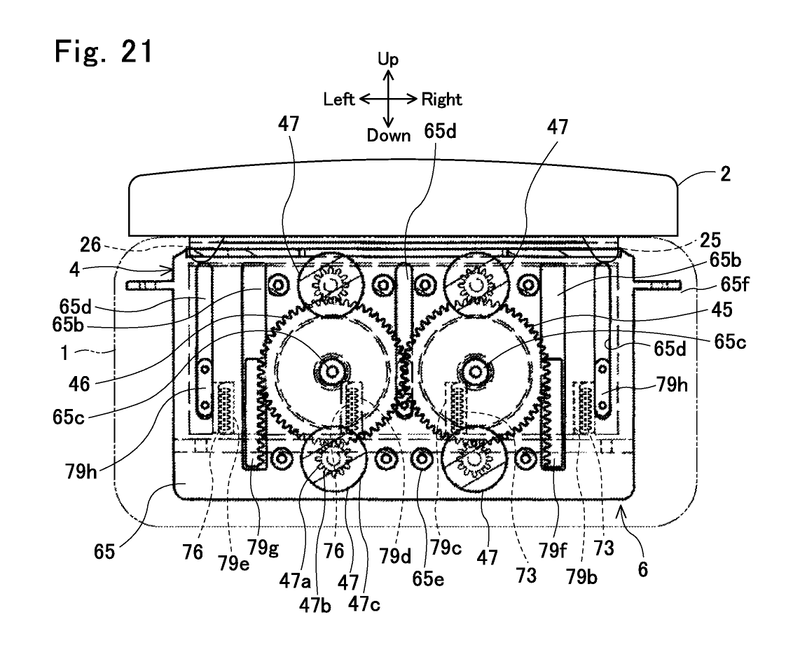

Further, as illustrated in FIG. 21, the base member 65 is provided with four damper devices 47. Each of the damper devices 47 includes viscous oil between a rotary section 47b having a gear 47a and a fixation section 47c to give a resistance to rotation of the gear 47a. The damper devices 47 are fixed, using a screw, to a screwed section 65e projecting to the base member 65 at two positions of the fixation sections 47c. The damper devices 47 are provided above and beneath the first pinion 45 and the second pinion 46, and alleviate a change in a rotational speed of the first pinion 45 and the second pinion 46.

An operation of the dual swing container device according to this embodiment will be described.

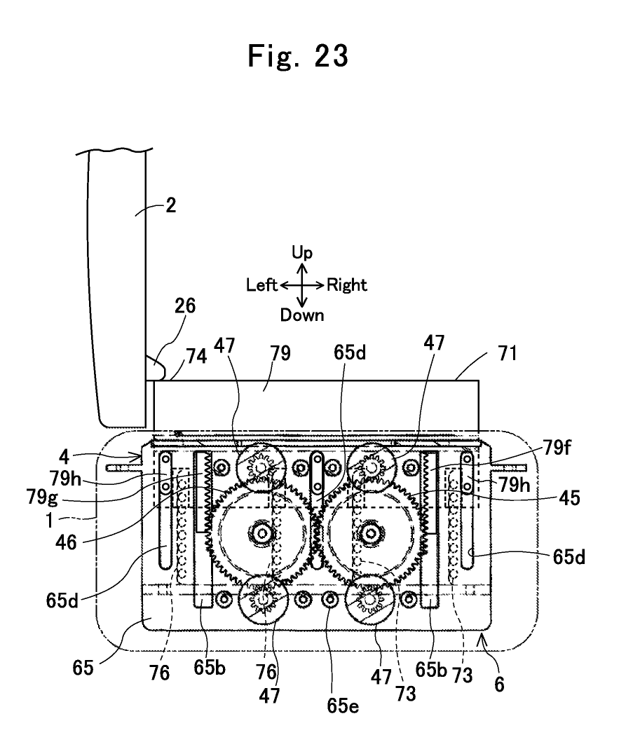

As illustrated in FIG. 21 and FIG. 22, when the right side of the cover body 2 is opened, the first pressing holding section 71 of the pressing body 79 attempts to advance by the first bias member 73. When the first pressing holding section 71 advances, the first rack section 79f of the pressing body 79 moves upward. With this, the first pinion 45 rotates to the left. The second pinion 46 that is engaged with the first pinion 45 rotates to the right. The second rack section 79g engaged with the second pinion 46 is moved upward, and the second pressing holding section 74 is moved to the advancing direction. With this, as illustrated in FIG. 23, the second pressing holding section 74 also advances in conjunction with the advancement of the first pressing holding section 71, and the pressing body 79 as a whole advances upward. Therefore, when the cover body 2 starts to open from the closed state, the first pressing holding section 71 and the second pressing holding section 74 are brought into contact with the first engaging section 25 and the second engaging section 26 projecting inside the cover body 2 to assist the opening operation of the cover body 2. Then, when the right side of the cover body 2 starts to open due to the swinging of the cover body 2, the first pressing holding section 71 swings up away from the first engaging section 25 on the right side, and the second engaging section 26 on the left side remains in contact with the second pressing holding section 74. The left side of the cover body 2 is held at the fully opened position (first opened position) of the right side of the cover body 2 by the second pressing holding section 74.

Similarly to the first embodiment, in this embodiment, as illustrated in FIG. 1, when the cover body 2 is positioned at the first opened position, the side wall 22b of the upper member 22 of the cover body 2 comes into the gaps 15 formed between the box main body 1 and the projection 12a of the front member 12 and the projection 13a of the rear member 13 on the left side and engaged with lower surfaces of the projections 12a and 13a. Therefore, it is possible to prevent the cover body 2 from falling over outwardly. In this manner, when the cover body 2 is positioned at the first opened position, by the upward force of the second pressing holding section 74 and the engagement of the left side of the side wall 22b with the projections 12a and 13a, it is possible to prevent the cover body 2 from falling over inwardly and outwardly.

As illustrated in FIG. 23, FIG. 22, and FIG. 21, as the cover body 2 falls to the right from the first opened position at which the right side of the cover body 2 is fully opened, the second pressing holding section 74 retracts. The second rack section 79g moves downward, and the second pinion 46 rotates to the left. The first pinion 45 rotates to the right to move the first rack section 79f downward. With this, the first pressing holding section 71 also retracts downward in conjunction with the downward retraction of the second pressing holding section 74, the pressing body 79 as a whole retracts within the box main body 1.

When the left side of the cover body 2 is opened, the first pressing holding section 71 on the right side also advances in conjunction with the advancement of the second pressing holding section 74 on the left side. Therefore, when the cover body 2 starts to open from the closed state, the first pressing holding section 71 and the second pressing holding section 74 are brought into contact with the first engaging section 25 and the second engaging section 26 of the cover body 2 to assist the opening operation of the cover body 2. Then, while the left side of the cover body 2 rotates after starting to open to the fully opened second opened position, the second pressing holding section 74 on the left side moves away from the second engaging section 26 of the cover body 2, and the first pressing holding section 71 on the right side remains in contact with the first engaging section 25 of the cover body 2. The right side of the cover body 2 is held at the fully opened position (second opened position) of the left side of the cover body 2 by the first pressing holding section 71. When the left side of the cover body 2 is closed, the second pressing holding section 74 also retracts in conjunction with the retraction of the first pressing holding section 71.

Unlike the first embodiment and the second embodiment, according to this embodiment, when the cover body 2 is at a position near the right closing position or at a position near the left closing position, the first pressing holding section 71 on the right side or the second pressing holding section 74 on the left side of the pressing body 79 retracts. Therefore, it is possible to alleviate a load required for closing the cover body 2, providing user-friendliness.

### Fourth Embodiment

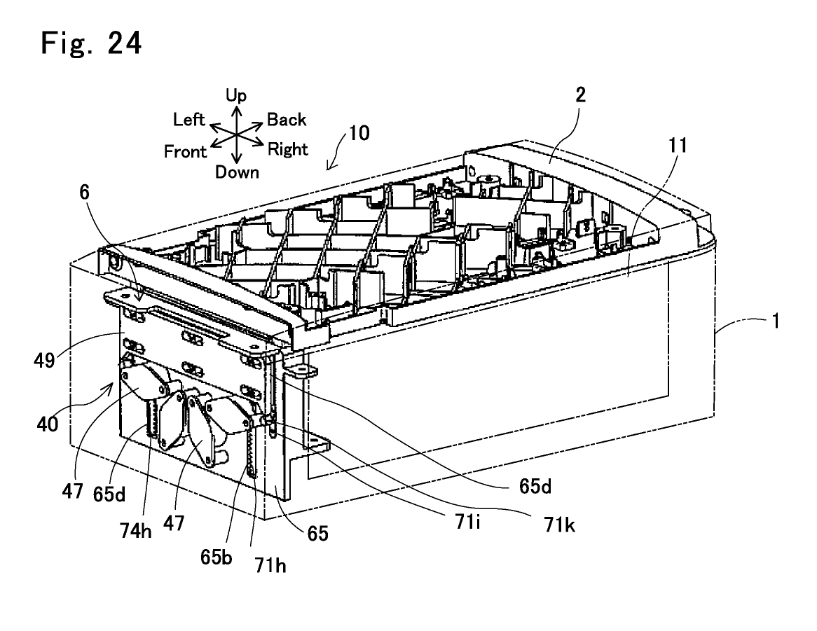

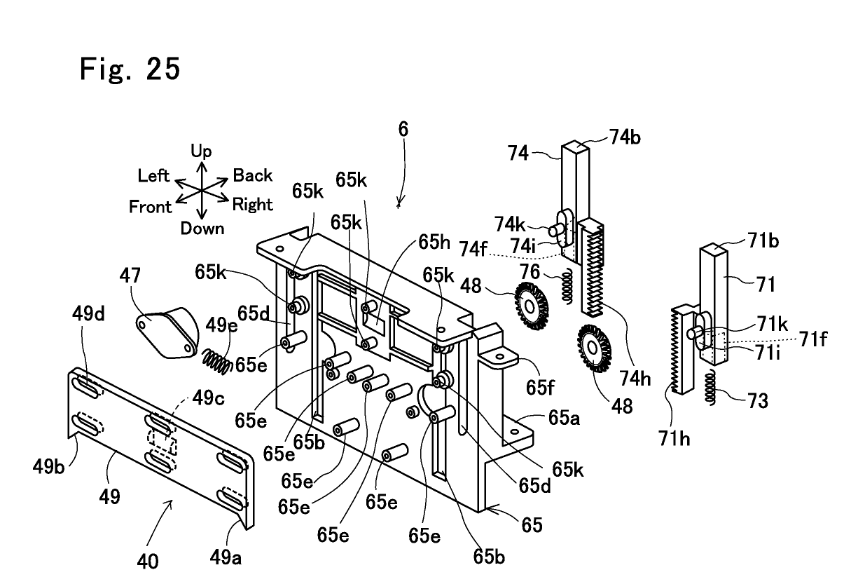

As illustrated in FIG. 24 to FIG. 26, according to the dual swing container device 10 of this embodiment, the opening operation assisting device 6 includes the base member 65, the first pressing holding section 71, the second pressing holding section 74, the first bias member 73, the second bias member 76, and an advancement adjustment mechanism 40. The base member 65 is fixed to the opening circumferential edge on the front side of the containing section 11 of the box main body 1. The base member 65 extends from the right end side to the left end side along the opening circumferential edge of the containing section 11 of the box main body 1.

The first pressing holding section 71 and the second pressing holding section 74 are separate members, and respectively disposed at the right end and the left end of the opening circumferential edge on the front side of the box main body 1. The first pressing holding section 71 and the second pressing holding section 74 are elongated members extending up and down direction. The first pressing holding section 71 and the second pressing holding section 74 respectively include engagement protrusions 71i and 74i projecting forward. The engagement protrusions 71i and 74i are respectively inserted into guiding holes 65d formed in the right-side section and the left-side section of the base member 65 in a manner movable up and down. In front of the engagement protrusions 71i and 74i, pins 71k and 74k are respectively projecting. The pins 71k and 74k are projecting forward from the guiding hole 65d, and move in the up and down direction respectively by the engagement protrusions 71i and 74i being guided through the guiding holes 65d.

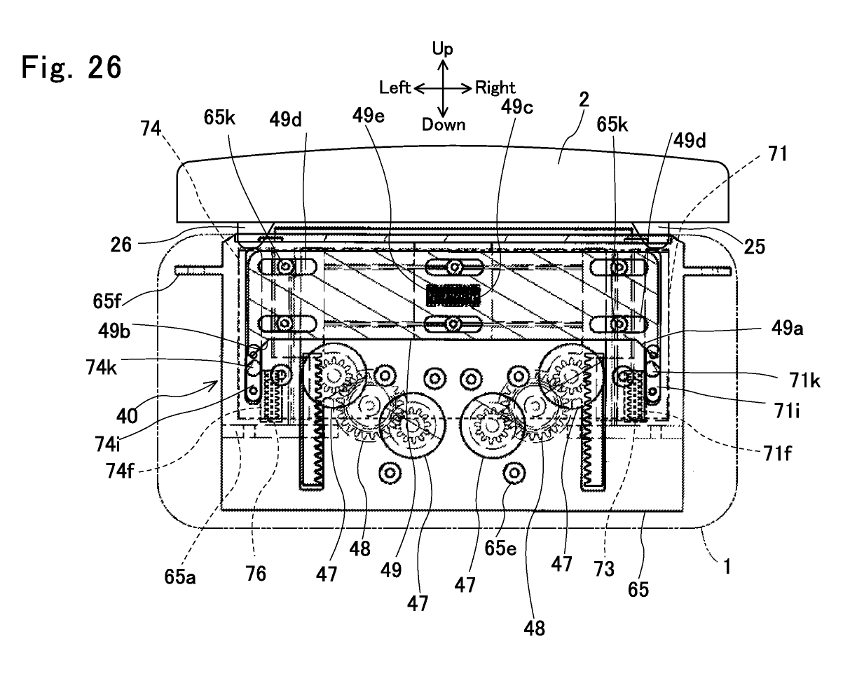

Upper surfaces of the first pressing holding section 71 and the second pressing holding section 74 are the contact surfaces 71b and 74b that press the cover body 2, and spring chambers 71f and 74f are formed on the lower parts of the first pressing holding section 71 and the second pressing holding section 74 (FIG. 26). The first bias member 73 and the second bias member 76 are helical compression springs, and are respectively provided between the spring chambers 71f and 74f of the first pressing holding section 71 and the second pressing holding section 74 and a seating section 65a provided on the base member 65 so as to bias the first pressing holding section 71 and the second pressing holding section 74 in the advancing direction (upward direction).

The first pressing holding section 71 and the second pressing holding section 74 are respectively provided with rack sections 71h and 74h inwardly in the right-left direction. The rack sections 71h and 74h is fitted by insertion in the slits 65b formed on the base member 65 in a manner movable up and down. Near each of the rack sections 71h and 74h, a pinion 48 is provided. Each pinion 48 is rotatably supported by the base member 65. Each pinion 48 is provided with two damper devices 47. One of the two damper devices 47 provided for each pinion 48 is disposed between the pinion 48 and the rack section 71h, and the other is disposed on the other side of the one damper device 47 with respect to the pinion 48. The damper devices 47 reduce the rotational speed of the pinion 48 to alleviate a change in a speed of advancement and retraction of the first pressing holding section 71 and the second pressing holding section 74.

The advancement adjustment mechanism 40 includes a sliding member 49 and a sliding bias member 49e. The sliding member 49 is an elongated thin plate extending in the right-left direction. The sliding member 49 is provided with a pair of upper and lower elongated holes 49d on a right-end section, a middle section, and a left-end section. The elongated holes 49d extend in the right-left direction. In each of the elongated holes 49d, a projection 65k provided on the base member 65 is inserted in a manner relatively movable in the right-left direction.

The sliding member 49 is provided between the first pressing holding section 71 and the second pressing holding section 74. The pin 71k of the first pressing holding section 71 and the pin 74k of the second pressing holding section 74 are respectively movable along movement loci in the up and down direction. The sliding member 49 is disposed between the movement locus of the pin 71k and the movement locus of the pin 74k, and supported on the base member 65 movably between the movement locus of the pin 71k and the movement locus of the pin 74k in the right-left direction. A right-end-side section and a left-end-side section of the sliding member 49 are formed with tapered surfaces 49a and 49b on surfaces of projecting sections projecting downward. The engagement protrusion 71i projecting on the first pressing holding section 71 and the engagement protrusion 74i projecting on the second pressing holding section 74 are respectively provided with the pins 71k and 74k projecting thereon. The tapered surface 49a of the right-end-side section and the tapered surface 49b of the left-end-side section of the sliding member 49 are respectively engaged with the pins 71k and 74k, and have the sliding member 49 slide in the right-left direction along with up-down movement of the first pressing holding section 71 and the second pressing holding section 74.

In the center of the sliding member 49 in the right-left direction, a semi-circular cylindrical recessed spring chamber 49c is provided. Further, in the center of the base member 65 in the right-left direction, a semi-circular cylindrical recessed spring chamber 65h is provided. In the spring chamber 49c of the sliding member 49 and the spring chamber 65h of the base member 65, the sliding bias member 49e is provided. The sliding bias member 49e biases the sliding member 49 so as to position in the middle of the moving path of the first pressing holding section 71 and the moving path of the second pressing holding section 74. A spring force of the sliding bias member 49e is smaller than spring forces of the first bias member 73 and the second bias member 76.

An operation of the dual swing container device 10 according to this embodiment will be described.

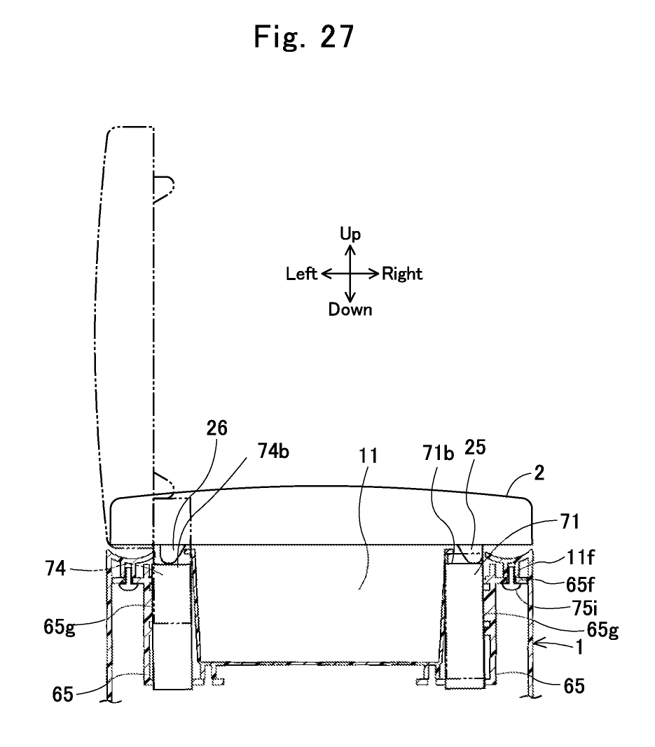

As illustrated in FIG. 26 and FIG. 27, when the right side of the cover body 2 is opened, the first pressing holding section 71 on the right side advances upward by the biasing force of the first bias member 73. The pin 71k of the first pressing holding section 71 moves upward, and presses the tapered surface 49a of the sliding member 49 on the right side diagonally upward right. With this, the sliding member 49 is pressed to the right.

As the upward movement of the pin 71k is restricted at the upper end of the tapered surface 49a, the upward movement of the first pressing holding section 71 is restricted. Therefore, the first pressing holding section 71 does not project from the opening circumferential edge of the box main body 1. Then, the sliding member 49 that has been pressed diagonally upward right is moved to the right, and retracts from the movement locus of the pin 74k of the second pressing holding section 74 on the left side. The second pressing holding section 74 advances upward by the biasing force of the second bias member 76. The contact surface 74b of the second pressing holding section 74 presses the second engaging section 26 of the left side of the cover body 2 to assist the opening operation of the cover body 2.

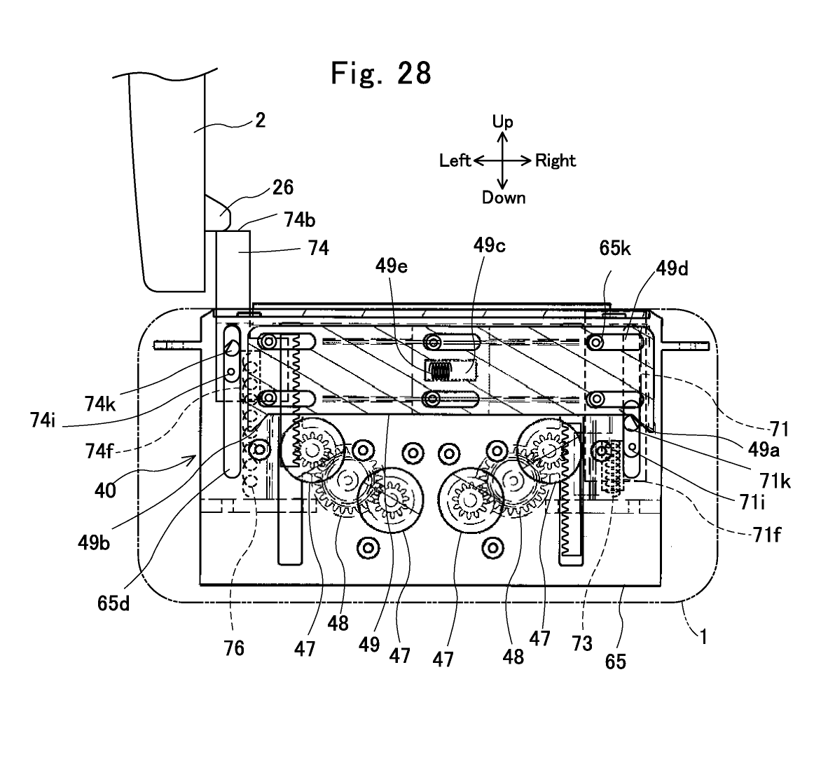

As illustrated in FIG. 28, when the right side of the cover body 2 opens to the fully opened position (first opened position), the second pressing holding section 74 on the left side engages with the second engaging section 26 of the cover body 2 to prevent the cover body 2 from falling over inwardly. Further, similarly to the first embodiment, the cover body 2 engages with a lower surface of the projection 12a of the front member 12 and a lower surface of the projection 13a of the rear member 13 on the left side. Therefore, it is possible to prevent the cover body 2 from falling over outwardly. In this manner, when the cover body 2 is positioned at the first opened position, by the upward force of the second pressing holding section 74 and the engagement of the left side of the side wall 22b with the projections 12a and 13a, it is possible to prevent the cover body 2 from falling over inwardly and outwardly.

When the cover body 2 falls to the right in this state, the second pressing holding section 74 retracts. The pin 74k of the second pressing holding section 74 is moved to a position under the sliding member 49. When the right side of the cover body 2 is about to close, the first engaging section 25 of the cover body 2 on the right side presses the contact surface 71b of the first pressing holding section 71 downward. The first pressing holding section 71 is moved downward. The pin 71k of the first pressing holding section 71 is moved downward, and along with this, the sliding member 49 is returned to the center by the biasing force of the sliding bias member 49e.

Next, when the left side of the cover body 2 is opened, the advancement of the second pressing holding section 74 on the left side is restricted by an upper end of the tapered surface 49b of the sliding member 49. As the sliding member 49 retracts from the movement locus of the pin 71k, the first pressing holding section 71 on the right side advances toward the cover body 2. Therefore, the right side of the cover body 2 is held by the first pressing holding section 71 at the position at which the left side of the cover body 2 is fully opened (second opened position). When the left side of the cover body 2 is closed, the second pressing holding section 74 moves downward after the retraction of the first pressing holding section 71.

Unlike the first to third embodiments, in the fourth embodiment, the first pressing holding section 71 or the second pressing holding section 74 on the side that the cover body 2 is opened does not project from the opening circumferential edge of the box main body. Therefore, appearance of the opening circumferential edge of the box main body 1 when the cover body 2 is open is favorable.

In the first to fourth embodiments, the opening operation assisting device 6 is disposed on the front side of the containing section 11 of the box main body 1. In this case, it is possible to smoothly open the front side of the cover body 2 near a passenger in the vehicle, providing user-friendliness. Alternatively, the opening operation assisting device 6 may be disposed on the back side of the containing section 11. In this case, the first pressing holding section 71 and the second pressing holding section 74 of the opening operation assisting device 6 are not easily seen from a passenger sitting in the front seat, and appearance of the dual swing container device 10 is favorable.

In the first to fourth embodiments, when the cover body 2 is open, the first pressing holding section 71 and/or the second pressing holding section 74 are configured to project from the box main body 1. However, the first pressing holding section 71 and/or the second pressing holding section 74 may be provided at lower positions and within the circumferential edge of the containing section 11 of the box main body 1. In this case, it is possible to configure such that portions of the cover body 2 in contact with the first pressing holding section 71 and the second pressing holding section 74 projects, and the cover body 2 is brought into contact with the first pressing holding section 71 and the second pressing holding section 74 when the cover body 2 is closed. By positioning the first pressing holding section 71 and the second pressing holding section 74 within the circumferential edge of the containing section 11 of the box main body 1, the first pressing holding section 71 and the second pressing holding section 74 are not seen convex when the cover body 2 is opened, providing good appearance.

In the first to fourth embodiments, the projections 12a and 13a of the front member 12 and the rear member 13 fixed to the box main body 1 server as a stopper, and by the side wall 22b of the upper member 22 of the cover body 2 engages with the projections, it is possible to prevent the cover body 2 from falling over to the opening side. However, as long as it is possible to prevent the cover body 2 from falling over to the opening side, a different configuration may be employed.

In the first to fourth embodiments, there is no link structure between the box main body 1 and the cover body 2. However, the opening operation assisting device 6 according to the present invention may be applied to the dual swing container device 10 having a link structure between the box main body 1 and the cover body 2.

In the first to fourth embodiments, either of the right-hand locking member 33 and the left-hand locking member 34 includes the first movable member 41 on the front side and the second movable member 42 on the back side, and as well as the gear member 43 between the first movable member 41 and the second movable member 42. The first movable member 41 and the second movable member 42 respectively include the rack gears 41a and 42a, and the gear member 43 includes the pinion gear 43a. Based on such a rack and pinion structure, the first movable member 41 and the second movable member 42 may advance or retract in synchronization with each other outwardly or inwardly in the front-back direction. By pressing the operating section 5 on the right or the left side in, the first movable member 41 and the second movable member 42 are disengaged from the engaging holes 14 and retract in synchronization, and therefore the locks on the front and the back side are unlocked in synchronization. In place of such a rack and pinion structure, it is possible to synchronously move the first movable member 41 and the second movable member 42 based on a link method.

The dual swing container device 10 according to the first to fourth embodiments is a console box for vehicles, but the present invention may be applied to other types of dual swing container devices.

(1) According to the first to fourth embodiments, the dual swing container device 10 of the present invention includes: a box main body 1 having a containing section 11; a cover body 2 capable of opening and closing from one (right) or the other (left) end side of the containing section 11; and an open-close mechanism 30 configured to have the cover body 2 open and close from the one or the other end side, wherein the open-close mechanism 30 includes: a locking device 31 configured to restrict the cover body 2 at a closed position; an operating section 5 configured to unlock the restriction of the cover body 2 at the closed position and allow the cover body 2 to open from the one or the other end side; and an opening operation assisting device 6 configured to open the cover body 2 from the one or the other end side, and hold the cover body 2 either at a first opened position or at a second opened position, the cover body 2 opening from the one end side at the first opened position, the cover body 2 opening from the other end side at the second opened position, and the opening operation assisting device 6 includes: a first pressing holding section 71 supported at the one end side of the box main body 1 so as to be able to advance toward the one end side of the cover body 2; a first bias member 73 configured to bias the first pressing holding section 71 toward the advancing direction; a second pressing holding section 74 supported at the other end side of the box main body 1 so as to be able to advance toward the other end side of the cover body 2; and a second bias member 76 configured to bias the second pressing holding section 74 toward the advancing direction.

According to the above configuration, the first pressing holding section 71 and the second pressing holding section 74 are provided at the one and the other end side of the box main body 1. The first pressing holding section 71 and the second pressing holding section 74 are respectively biased to the advancing direction by the first bias member 73 and the second bias member 76. With this, when the one or the other end side of the cover body 2 is able to be opened, the first pressing holding section 71 and/or the second pressing holding section 74 open the cover body 2, and hold the opened cover body 2 at the first opened position or the second opened position. Thus, it is possible to assist the opening operation of the cover body 2 with simple configuration, providing user-friendliness.

Therefore, according to the above configuration, it is possible to provide a dual swing container device having a simple configuration.

In addition, as the cover body 2 does not include any mechanism such as an opening spring for holding the opening operation of the cover body 2, it is possible to reduce the weight and the thickness of the cover body 2.

(2) In the first and second embodiments, the first pressing holding section 71 is configured to push the cover body 2 up toward the first opened position when the cover body 2 is openable from the one end side, and hold the cover body 2 at the second opened position in engagement with the one end side of the cover body 2 when the cover body 2 opens on the other end side, and the second pressing holding section 74 is configured to push the cover body 2 up toward the second opened position when the cover body 2 is openable from the other end side, and hold the cover body 2 at the first opened position in engagement with the other end side of the cover body 2 when the cover body 2 opens on the one end side.

According to the above configuration, when the lock at the closed position on the one end side of the cover body 2 is unlocked by the operating section 5 and the cover body 2 is openable from the one end side, the first pressing holding section 71 pushes the one end side of the cover body 2 up to open the one end side of the cover body 2. When the lock at the closed position on the other end side of the cover body 2 is unlocked by the operating section 5 and the other end side of the cover body 2 opens, the first pressing holding section 71 engages with the one end side of the cover body 2 and holds the cover body 2 at the second opened position.

The second pressing holding section 74 is biased by the second bias member 76 to the advancing direction. With this, when the lock at the closed position on the other end side of the cover body 2 is unlocked by the operating section 5 and the cover body 2 is openable from the other end side, the second pressing holding section 74 pushes the other end side of the cover body 2 up to open the other end side of the cover body 2. When the lock at the closed position on the one end side of the cover body 2 is unlocked by the operating section 5 and the one end side of the cover body 2 opens, the second pressing holding section 74 engages with the other end side of the cover body 2 and holds the cover body 2 at the first opened position.

(3) In the second embodiment, there is provided a swinging body 77 extending along an opening circumferential edge of the containing section 11 of the box main body 1 across the one end side to the other end side, and capable of swinging so as to press the one or the other end side of the cover body 2 toward either the first opened position or the second opened position, wherein the first pressing holding section 71 is provided on the one end side of the swinging body 77, and the second pressing holding section 74 is provided on the other end side of the swinging body 77.

According to the above configuration, when the one end side of the cover body 2 opens, the swinging body 77 swings and the first pressing holding section 71 first advances so as to push the one end side of the cover body 2 up. When the cover body 2 opens to the first opened position, the second pressing holding section 74 later advances to hold the other end side of the cover body 2. In this manner, by delaying timings of advancement of the first pressing holding section 71 and the second pressing holding section 74, it is possible to assist the opening operation by having one of the first pressing holding section 71 and the second pressing holding section 74 on the side that the cover body 2 opens first advance. Then, by having the other of the first pressing holding section 71 and the second pressing holding section 74 advance, the cover body 2 may be held so as to be maintained at the first opened position or the second opened position.

In this manner, by causing the swinging body 77 to swing, the timings and the amounts of advancement of the first pressing holding section 71 and the second pressing holding section 74 may be made different. By allowing delay in the timings of advancement, and changing the amounts of advancement if necessary, of the first pressing holding section 71 and the second pressing holding section 74, and making the amounts of advancement to be different as needed, it is possible to open the cover body 2 smoothly, and to hold the opened cover body 2 stably at the first opened position or the second opened position.

(4) In the third and fourth embodiments, when the cover body 2 opens on the other end side, the first pressing holding section 71 holds the cover body 2 at the second opened position by pushing the cover body 2 up toward the second opened position in engagement with the one end side of the cover body 2, and when the cover body 2 opens on the one end side, the second pressing holding section 74 holds the cover body 2 at the first opened position by pushing the cover body 2 up toward the first opened position in engagement with the other end side of the cover body 2.

According to the above configuration, when the lock at the closed position on the other end side of the cover body 2 is unlocked by the operating section 5 and the cover body 2 is openable from the other end side, the first pressing holding section 71 engages with the one end side of the cover body 2 and pushes the cover body 2 to the second opened position up to hold the cover body 2 at the second opened position.

When the lock at the closed position on the one end side of the cover body 2 is unlocked by the operating section 5 and the cover body 2 is openable from the one end side, the second pressing holding section 74 engages with the other end side of the cover body 2 and pushes the cover body 2 to the first opened position up to hold the cover body 2 at the first opened position.

(5) In the first embodiment, the first pressing holding section 71 and the second pressing holding section 74 are separate members.

According to the above configuration, the movement of the first pressing holding section 71 is not influenced by the second pressing holding section 74. The first pressing holding section 71 and the second pressing holding section 74 are not influenced by the timings and the amounts of advancement of each other. When the one end side of the cover body 2 is openable, the first pressing holding section 71 may push the one end side of the cover body 2 up, and then the second pressing holding section 74 may advance and engage with the other end side of the cover body 2 and hold the cover body 2 at the first opened position. On the other hand, when the other end side of the cover body 2 is openable, the second pressing holding section 74 may push the other end side of the cover body 2 up, and then the first pressing holding section 71 may advance and engage with the one end side of the cover body 2 and hold the cover body 2 at the second opened position. In this manner, by allowing delay in the timings of advancement, and changing the amounts of advancement if necessary, of the first pressing holding section 71 and the second pressing holding section 74, it is possible to open the cover body 2 smoothly, and to hold the opened cover body 2 stably at the first opened position or the second opened position.

(6) In the third embodiment, there is provided a pressing body 79 extending along an opening circumferential edge of the containing section 11 of the box main body 1 across the one end side to the other end side, and capable of advancing forward so as to press the one or the other end side of the cover body toward either the first opened position or the second opened position, wherein the first pressing holding section 71 is provided on the one end side of the pressing body 79, and the second pressing holding section 74 is provided on the other end side of the pressing body 79, and the opening operation assisting device 6 further includes: an advancement retraction interlocking mechanism 4 for causing the second pressing holding section 74 to advance or retract in conjunction with advancement or retraction of the first pressing holding section 71, as well as for causing the first pressing holding section 71 to advance or retract in conjunction with advancement or retraction of the second pressing holding section 74.

According to the above configuration, when the one end side or the other end side of the cover body 2 opens, the first pressing holding section 71 of the pressing body 79 and the second pressing holding section 74 advance in conjunction with each other, and press the cover body 2 to the first opened position or the second opened position to hold the cover body 2 at the first opened position or the second opened position. Further, when the one end side or the other end side of the cover body is about to close, the first pressing holding section 71 on the one end side or the second pressing holding section 74 on the other end side of the pressing body 79 retract. Therefore, it is possible to alleviate a load required for closing the cover body, providing user-friendliness.

(7) In the third embodiment, the advancement retraction interlocking mechanism 4 includes: a first rack section 79f provided on the one end side of the pressing body 79; a first pinion 45 rotatably supported on a the box main body side so as to be engaged with the first rack section 79f; a second rack section 79g provided on the other end side of the pressing body 79; and a second pinion 46 rotatably supported on the box main body side so as to be in external contact with the first pinion 45 and engaged with the second rack section 79g.

According to the above configuration, when the one end side of the cover body 2 is opened, the second pressing holding section 74 also advances in conjunction with the advancement of the first pressing holding section 71, and the pressing body 79 as a whole advances upward. Therefore, the other end side of the cover body 2 is held at the fully opened position on the one end side of the cover body 2 (first opened position) by the second pressing holding section 74. When the other end side of the cover body 2 is opened, the first pressing holding section 71 also advances in conjunction with the advancement of the second pressing holding section 74, and the pressing body 79 as a whole advances upward. Therefore, the one end side of the cover body 2 is held at the fully opened position on the other end side of the cover body 2 (second opened position) by the first pressing holding section 71.

Further, the second pressing holding section 74 retracts in conjunction with the retraction of the first pressing holding section 71. Moreover, the first pressing holding section 71 retracts in conjunction with the retraction of the second pressing holding section 74. Therefore, when the one end side or the other end side of the cover body 2 is about to close, the first pressing holding section 71 on the one end side or the second pressing holding section 74 on the other end side of the pressing body 79 retract. Therefore, it is possible to alleviate a load required for closing the cover body, providing user-friendliness.

(8) In the fourth embodiment, the first pressing holding section 71 and the second pressing holding section 74 are separate members, and the opening operation assisting device 6 further includes: an advancement adjustment mechanism 40 for allowing the first pressing holding section 71 to advance while restricting advancement of the second pressing holding section 74 when the cover body 2 opens on the other end side, and for allowing the second pressing holding section 74 to advance while restricting advancement of the first pressing holding section 71 when the cover body 2 opens on the one end side.

According to the above configuration, when the other end side of the cover body 2 opens, the advancement of the second pressing holding section 74 is restricted. When the one end side of the cover body 2 opens, the advancement of the first pressing holding section 71 is restricted. Therefore, the advancement of the first pressing holding section 71 or the second pressing holding section 74 on the side that the cover body 2 is opened is restricted, and an amount of projection from the opening circumferential edge of the box main body 1 is reduced. Therefore, appearance of the opening circumferential edge of the box main body 1 when the cover body 2 is open is favorable.

(9) In the fourth embodiment, the advancement adjustment mechanism 40 includes: a sliding member 49 disposed across a moving path of the first pressing holding section 71 and a moving path of the moving path of the second pressing holding section 74, and supported on the box main body 1 side movably between the moving path of the first pressing holding section 71 and the moving path of the second pressing holding section 74; and a sliding bias member 49e for biasing the sliding member 49 toward a direction so that the sliding member 49 is centrally-located between the moving path of the first pressing holding section 71 and the moving path of the second pressing holding section 74, and the sliding member 49 includes: a first displacement section (a tapered surface 49a) for moving the sliding member 49 toward the first pressing holding section 71 until the sliding member 49 comes out the moving path of the second pressing holding section 74, when the cover body 2 opens on the one end side, along with upward movement of the first pressing holding section 71; a first advancement restricting section (an upper end of the tapered surface 49a) for restricting the upward movement of the first pressing holding section 71 when the cover body 2 opens on the one end side to a predetermined amount; a second displacement section (a tapered surface 49b) for moving the sliding member 49 toward the second pressing holding section 74 until the sliding member 49 comes out the moving path of the first pressing holding section 71, when the cover body 2 opens on the other end side, along with upward movement of the second pressing holding section 74; and a second advancement restricting section (an upper end of the tapered surface 49b) for restricting the upward movement of the second pressing holding section 74 when the cover body 2 opens on the other end side to a predetermined amount.

According to the above configuration, when the one end side of the cover body 2 opens, the upward movement of the first pressing holding section 71 is restricted, when the other end side of the cover body 2 opens, the upward movement of the second pressing holding section 74 is restricted. Therefore, as the advancement of the first pressing holding section 71 or the second pressing holding section 74 on the side that the cover body 2 is opened is restricted, an amount of projection from the opening circumferential edge of the box main body 1 is reduced, providing good appearance.

(10) In the first to fourth embodiments, a first engaging section 25 is provided on the one end side of the cover body 2, the first engaging section 25 being engaged with the first pressing holding section 71 when the cover body is at the second opened position, and a second engaging section 26 is provided on the other end side of the cover body 2, the second engaging section 26 being engaged with the second pressing holding section 74 when the cover body 2 is at the first opened position.

According to the above configuration, when the cover body 2 is at the first opened position, the engagement of the second engaging section 26 of the cover body 2 on the other end side with the second pressing holding section 74 is ensured. When the cover body 2 is at the second opened position, the engagement of the first engaging section 25 of the cover body 2 on the one end side with the first pressing holding section 71 is ensured.

What is claimed is:

1. A dual swing container device comprising:
a box main body having a containing section;
a cover body capable of opening and closing from one or the other end side of the containing section; and
an open-close mechanism configured to have the cover body open and close from the one or the other end side, wherein
the open-close mechanism includes:
a locking device configured to restrict the cover body at a closed position;
an operating section configured to unlock the restriction of the cover body at the closed position and allow the cover body to open from the one or the other end side; and
an opening operation assisting device configured to open the cover body from the one or the other end side, and hold the cover body either at a first opened position or at a second opened position, the cover body opening from the one end side at the first opened position, the cover body opening from the other end side at the second opened position, and
the opening operation assisting device includes:
a first pressing holding section supported at the one end side of the box main body so as to be able to advance toward the one end side of the cover body;
a first bias member configured to bias the first pressing holding section toward the advancing direction;
a second pressing holding section supported at the other end side of the box main body so as to be able to advance toward the other end side of the cover body; and
a second bias member configured to bias the second pressing holding section toward the advancing direction.

2. The dual swing container device according to claim 1, wherein
the first pressing holding section is configured to push the cover body up toward the first opened position when the cover body is openable from the one end side, and hold the cover body at the second opened position in engagement with the one end side of the cover body when the cover body opens on the other end side, and
the second pressing holding section is configured to push the cover body up toward the second opened position when the cover body is openable from the other end side, and hold the cover body at the first opened position in engagement with the other end side of the cover body when the cover body opens on the one end side.

3. The dual swing container device according to claim 2, comprising:
a swinging body extending along an opening circumferential edge of the containing section of the box main body across the one end side to the other end side, and capable of swinging so as to press the one or the other end side of the cover body toward either the first opened position or the second opened position, wherein
the first pressing holding section is provided on the one end side of the swinging body, and the second pressing holding section is provided on the other end side of the swinging body.

4. The dual swing container device according to claim 1, wherein
when the cover body opens on the other end side, the first pressing holding section holds the cover body at the second opened position by pushing the cover body up toward the second opened position in engagement with the one end side of the cover body, and
when the cover body opens on the one end side, the second pressing holding section holds the cover body at the first opened position by pushing the cover body up toward the first opened position in engagement with the other end side of the cover body.

5. The dual swing container device according to claim 1, wherein
the first pressing holding section and the second pressing holding section are separate members.

6. The dual swing container device according to claim 1, comprising:
a pressing body extending along an opening circumferential edge of the containing section of the box main body across the one end side to the other end side, and capable of advancing forward so as to press the one or the other end side of the cover body toward either the first opened position or the second opened position, wherein
the first pressing holding section is provided on the one end side of the pressing body, and the second pressing holding section is provided on the other end side of the pressing body, and
the opening operation assisting device further includes:
an advancement retraction interlocking mechanism for causing the second pressing holding section to advance or retract in conjunction with advancement or retraction of the first pressing holding section, as well as for causing the first pressing holding section to advance or retract in conjunction with advancement or retraction of the second pressing holding section.

7. The dual swing container device according to claim 6, wherein
the advancement retraction interlocking mechanism includes:
a first rack section provided on the one end side of the pressing body;
a first pinion rotatably supported on a box main body side so as to be engaged with the first rack section;
a second rack section provided on the other end side of the pressing body; and
a second pinion rotatably supported on the box main body side so as to be in external contact with the first pinion and engaged with the second rack section.

8. The dual swing container device according to claim 1, wherein
the first pressing holding section and the second pressing holding section are separate members, and
the opening operation assisting device further includes:
an advancement adjustment mechanism for allowing the first pressing holding section to advance while restricting advancement of the second pressing holding section when the cover body opens on the other end side, and for allowing the second pressing holding section to advance while restricting advancement of the first pressing holding section when the cover body opens on the one end side.

9. The dual swing container device according to claim 8, wherein
the advancement adjustment mechanism includes:
a sliding member disposed across a moving path of the first pressing holding section and a moving path of the second pressing holding section, and supported on the box main body side movably between the moving path of the first pressing holding section and the moving path of the second pressing holding section; and
a sliding bias member for biasing the sliding member toward a direction so that the sliding member is centrally-located between the moving path of the first pressing holding section and the moving path of the second pressing holding section, and
the sliding member includes:
a first displacement section for moving the sliding member toward the first pressing holding section until the sliding member comes out the moving path of the second pressing holding section, when the cover body opens on the one end side, along with upward movement of the first pressing holding section;
a first advancement restricting section for restricting the upward movement of the first pressing holding section when the cover body opens on the one end side to a predetermined amount;
a second displacement section for moving the sliding member toward the second pressing holding section until the sliding member comes out the moving path of the first pressing holding section, when the cover body opens on the other end side, along with upward movement of the second pressing holding section; and
a second advancement restricting section for restricting the upward movement of the second pressing holding section when the cover body opens on the other end side to a predetermined amount.

10. The dual swing container device according to claim 1, wherein
a first engaging section is provided on the one end side of the cover body, the first engaging section being engaged with the first pressing holding section when the cover body is at the second opened position, and
a second engaging section is provided on the other end side of the cover body, the second engaging section being engaged with the second pressing holding section when the cover body is at the first opened position.
